(19) United States
(12) Patent Application Publication
(10) Pub. No.: US 2023/0349719 A1
(43) Pub. Date: Nov. 2, 2023

(54) MAP GENERATION APPARATUS, MAP GENERATION PROGRAM AND ON-VEHICLE EQUIPMENT

(71) Applicant: DENSO CORPORATION, Kariya-city (JP)

(72) Inventors: Satoshi HORIHATA, Kariya-city (JP); Shigehiro MUTO, Kariya-city (JP)

(21) Appl. No.: 18/349,858

(22) Filed: Jul. 10, 2023

Related U.S. Application Data
(63) Continuation of application No. PCT/JP2021/047633, filed on Dec. 22, 2021.

(30) Foreign Application Priority Data
Jan. 12, 2021 (JP) 2021-002915

(51) Int. Cl. G01C 21/00; G08G 1/13; G08G 1/01

(52) U.S. Cl. CPC G01C 21/3841; G01C 21/3815; G08G 1/0112; G08G 1/13

(57) ABSTRACT

A server is provided with a probe data acquiring unit that acquires probe data from a plurality of vehicles; a signal information identifying unit that identifies, for a plurality of signals in an intersection, signal information related to respective signals based on the probe data; a stop line information identifying unit that identifies, for a plurality of stop lines in the intersection, stop line information related to respective stop lines based on the probe data; and a pairing unit that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination.

### CROSS-REFERENCE OF RELATED APPLICATION

This application is the U.S. bypass application of International Application No. PCT/JP2021/047633 filed on Dec. 22, 2021, which designated the U.S. and claims priority to Japanese Patent Application No. 2021-002915 filed on Jan. 12, 2021, the contents of both of these are incorporated herein by reference.

### BACKGROUND

### Technical Field

The present disclosure relates to a map generation apparatus, a map generation program and an on-vehicle equipment.

### Description of the Related Art

A map generation apparatus is known in which probe data including a camera image for a travelling direction of a vehicle is acquired and a map is generated based on the acquired probe data. For example, according to a map utilized for in the field of autonomous driving, signal information related to a signal and stop line information in an intersection are required to be paired in order to stop an autonomous driving vehicle before the stop line in the intersection.

### SUMMARY

According to one aspect of the present disclosure, a probe data acquiring unit acquires probe data from a plurality of vehicles. A signal information identifying unit identifies, for a plurality of signals in an intersection, signal information related to respective signals based on the probe data. A stop line information identifying unit identifies, for a plurality of stop lines in the intersection, stop line information related to respective stop lines based on the probe data. A pairing unit identifies, using a method for identifying a plurality of pairing candidates, a combination of the signal and the stop line as pairing candidates among a plurality of signals in the intersection and a plurality of stop lines in the intersection, and pairs the signal information and the stop line information based on an identification result of the combination.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a functional block diagram showing an overall configuration of a map generation system according to one embodiment;

FIG. 2 is a diagram showing a positional relationship between a vehicle location and a stop line;

FIG. 3 is a diagram showing a positional relationship between a vehicle location and a stop line;

FIG. 4 is a diagram showing a positional relationship between a vehicle location and a stop line;

FIG. 5 is a diagram showing a positional relationship between a vehicle location and a stop line;

FIG. 6 is a diagram showing a positional relationship between a signal and a stop line;

FIG. 7 is a diagram showing a positional relationship between a signal and a stop line;

FIG. 8 is a diagram showing an appearance between a signal and a stop line in an intersection;

FIG. 9 is a correspondence table between signal information and stop line information;

FIG. 10 is a diagram showing an appearance between a signal and a stop line in an intersection;

FIG. 11 is a correspondence table between signal information and stop line information;

FIG. 12 is a diagram showing an appearance between a signal and a stop line in an intersection;

FIG. 13 is a correspondence table between signal information and stop line information;

FIG. 14 is a flowchart showing a probe data transmission process;

FIG. 15 is a flowchart showing a probe data reception process;

FIG. 16 is a flowchart showing a pairing information generation process when a provisional pairing is present;

FIG. 17 is a table showing provisional pairing information and determined pairing information

FIG. 18 is a flowchart showing a pairing information generation process without provisional pairing information;

FIG. 19 is a diagram showing pairing information;

FIG. 20 is a diagram showing positional information between a signal and a stop line;

FIG. 21 is a correspondence table between signal information and stop line information;

FIG. 22 is a diagram showing a positional relationship between a signal and a pedestrian-crossing;

FIG. 23 is a correspondence table showing signal information and pedestrian-crossing information;

FIG. 24 is a flowchart showing a pairing correctness determination process; and

FIG. 25 is a flowchart showing a pairing correctness determination process.

### DETAILED DESCRIPTION OF THE PREFERRED EMBODIMENTS

A map generation apparatus is known in which probe data including a camera image for a travelling direction of a vehicle is acquired and a map is generated based on the acquired probe data. For example, according to a map utilized for in the field of autonomous driving, signal information related to a signal and stop line information in an intersection are required to be paired in order to stop an autonomous driving vehicle before the stop line in the intersection. For example, JP-A-2018-5629 discloses a technique in which signal information related to one signal and stop line information related to one stop line are paired due to a specific scene where one information collecting vehicle is stopping before the stop line due to a red signal in an intersection.

According to a method of the above-mentioned patent literature, the signal information and the stop line information are paired using a partial optimization for one signal and one stop line. Hence, in order to pair the signal information for all of the signals and all of the stop lines in the intersection, one information collecting vehicle is required to produce the above-described specific scene for the whole signals. As a result, a problem arises in which it is difficult to complete the pairing between the signal information and the stop line information for the whole signals in the intersection as pairing objects.

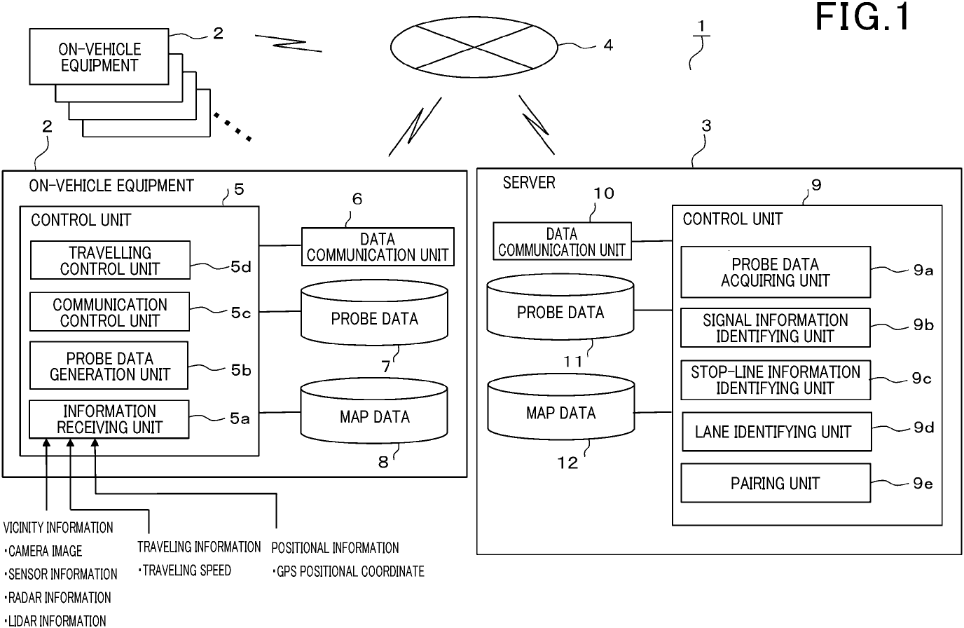

Hereinafter, with reference to the drawings, an embodiment of the present disclosure will be described. As shown in FIG. 1, a map generation system 1 is configured such that an on-vehicle equipment 2 mounted on a vehicle and a server 3 arranged in a network side are communicably connected via a communication network 4, for example including the internet. The vehicle to which the on-vehicle equipment 2 is mounted may or may not have an autonomous driving function. For the on-vehicle equipment 2 and the server 3, a plurality of on-vehicle equipment 2 and a single server 3 are present such that the server 3 is able to perform data communication with the plurality of on-vehicle equipment 2. The server 3 corresponds to a map generation apparatus.

The on-vehicle equipment 2 is provided with a control unit 5, a data communication unit 6, a probe data storage unit 7 and a map data storage unit 8. The control unit 5 is configured of a microcomputer including CPU (central processing unit), ROM (read only memory), RAM (random access memory) and I/O (input/output). The microcomputer executes a computer program stored in a non-transitory tangible recording media to execute processes corresponding to the computer program, thereby controlling overall operations of the on-vehicle equipment 2.

The control unit 5 is provided with an information receiving unit 5a, a probe data generation unit 5b, a communication control unit 5c and a travelling control unit 5d. The information receiving unit 5a receives vicinity information regarding the vicinity of the vehicle, traveling information about vehicle-travelling, positional information about a vehicle location. The information receiving unit 5a receives, as the vicinity information, a camera image of an area in a travelling direction of the vehicle captured by an on-vehicle camera, sensor information acquired by sensors such as millimeter wave sensor that detect surroundings of the vehicle, radar information acquired by a radar device that detects surroundings of the vehicle, LiDAR information acquired by LiDAR (light detection and ranging, laser imaging detection and ranging) that detect surroundings of the vehicle. The camera image may include signals, traffic signs, sign boards, stop lines painted on the road surface, lane markings, pedestrian crossings provided on a road. The information receiving unit 5a receives, as travelling speed information detected by a travelling speed sensor. The information receiving unit 5a receives a GPS (global positioning system) position coordinate measured in accordance with a GPS signal transmitted from the GPS satellite. The GPS position coordinate refers to a coordinate indicating the own vehicle location. As a satellite navigation system, it is not limited to GPS, but various GNSS (global navigation satellite system) such as GLONASS, Galileo, BeiDou, IRSS and the like can be utilized.

When the vicinity information, travelling information and the positional information are transmitted to the information receiving unit 5b, the probe data generation unit 5b generates probe data from the various transmitted information and causes the probe data storage unit 7 to store the generated probe data. The probe data is configured to include the vicinity information, the travelling information and the positional information. The probe data indicates a position, a color, a feature, and a relative positional relationship of the signals provided on the road, the traffic signs, the sign boards, the stop lines painted on the road surface, the lane markings, pedestrian crossings and the like. Also, the probe data includes various information such as road shape, road features, road width for the road where the vehicle is travelling.

The communication control unit 5c reads the probe data stored in the probe data storage unit 7 when a predetermined period elapses or the travelling distance of the vehicle reaches a predetermined distance and causes the data communication unit 6 to transmit the read probe data to the server 3. Further, instead of using the above-described period or the travelling distance as a trigger of reading and transmitting the probe data, as long as the server 3 is configured to transmit a probe data transmission request to the on-vehicle equipment 2 at predetermined periods, the communication control unit 5c may read the probe data stored in the probe data storage unit 7 and cause the data communication unit 6 to transmit the read probe data to the server 3 at a time when the data communication unit 6 receives the probe data transmission request transmitted from the server 3. When causing the data transmission unit 6 to transmit the probe data to the server 3, the communication control unit 5c may cause the data transmission unit 6 to transmit the probe data in a segment unit corresponding to a unit of area determined in advance for managing the map to the server 3, or may cause the data transmission unit 6 to transmit the probe data corresponding to a unit of area different from the area of the segment unit

The travelling control unit 5d, when the data communication unit 6 receives a map data transmitted from the server 3, causes the map data storage unit 8 to store the received map data, reads the map data including necessary information depending on the own vehicle location from the map data storage unit 8, and performs travelling control of the vehicle in accordance with the read map data. The travelling control unit 5d may cause the map data storage unit 8 to store a wide-area map data in advance and successively read a local map data depending on the own vehicle location to perform the travelling control of the vehicle, or may cause the data communication unit 6 to transmit a map data transmission request depending on the own vehicle location to the server 3 and successively acquire the local map data depending on the own vehicle location from the server 3.

The server 3 is provided with a control unit 9, a data communication unit 10, a probe data storage unit 11 and a map data storage unit 12. The control unit 9 is configured of a microcomputer including CPU, ROM, RAM and I/O. The microcomputer executes a computer program stored in a non-transitory tangible recording media to execute processes corresponding to the computer program, thereby controlling overall operations of the server 3. The computer program executed by the microcomputer includes a map generation program.

The control unit 9 is provided with a probe data acquiring unit 9a, a signal information identifying unit 9b, a stop line information identifying unit 9c, a lane identifying unit 9d and a pairing unit 9e. The probe data acquiring unit 9a, when the data communication unit 10 receives the probe data transmitted from the on-vehicle equipment 2, causes the probe data storage unit 11 to store the received probe data and reads probe data as necessary information, thereby acquiring the probe data. The probe data acquiring unit 9a acquires the probe data from a plurality of vehicles when the data communication unit 10 receives the probe data transmitted from the respective on-vehicle equipment 2 mounted on the plurality vehicles.

The signal information identifying unit 9b identifies, for a plurality of signals in the intersection, signal information of the respective signals in accordance with the probe data acquired by the probe data acquiring unit 9a. The signal information is managed associated with a signal ID capable of identifying the signal. The signal information includes a signal location with which the location of the signal can be identified, a signal size with which the size of the signal can be identified, a lighting direction, a lighting color, a signal type with which the type of signal can be identified and the like. The signal location is expressed by a three-dimensional coordinate indicating the center of the signal, for example. The signal size is expressed by, for example, a positional coordinate of the center of the signal, a positional coordinate of an end point of the signal, a dimension in the width direction (horizontal direction), a dimension in the height direction (vertical direction) and the like. The lighting direction is a normal vector direction of the signal which is expressed by a normal vector perpendicular to a direction along which signal lamps are arranged. The lighting color is expressed by a color (green) indicating permission for entering the intersection area, a color (yellow) indicating permission for moving while paying attention to other traffic and a color (red) indicating prohibition from entering the intersection and the like. The signal type refers to a type of signal differentiated by, for example, presence or absence of right turn permission or left turn permission.

The stop line information identifying unit 9c identifies, based on the probe data acquired by the probe data acquiring unit 9a, stop line information for respective stop lines in a plurality of stop lines in the intersection. The stop line information is managed associating with a stop line ID capable of identifying the stop line. The stop line information includes a stop line position capable of identifying the position of the stop line, a stop line size capable of identifying the size of the stop line and a stop line type capable of type of the stop line. The stop line position is expressed by a three-dimensional coordinate indicating the center of the stop line, for example. The stop line size is expressed by, for example, a positional coordinate of the center of the stop line, a positional coordinate of an end point of the stop line, a dimension in the width direction (road-width direction), a dimension in a depth direction (lane marking direction) and the like. The stop line type refers to a type of stop line differentiated by, for example, presence or absence of a pedestrian-crossing arranged in parallel to the stop line.

The lane identifying unit 9d identifies, based on the probe data acquired by the probe data acquiring unit 9a, a travelling lane on which the vehicle is travelling. In this case, the lane identifying unit 9d applies statistical processing to a plurality of data groups showing a vehicle trajectory and a lane marking, thereby identifying the travelling lane. In other words, the lane identifying unit 9d excludes data outside a predetermined range among a plurality of data group showing the vehicle trajectory and the lane marking and performs an averaging process for the data in the predetermines range to identify a lane center line, thereby identifying the travelling lane.

The pairing unit 9e identifies, using a method for identifying a plurality of pairing candidates, a combination of a signal and a stop line as a pairing candidate among a plurality of signals in the intersection and a plurality of stop lines in the intersection. The pairing unit 9e, when it has identified the combinations of the signal and the stop line, pairs the signal information and the stop line information, based on the identified result of the combination, thereby generating the pairing information. As described above, since the signal information is managed using the signal ID associating with a signal location, a signal size, a lighting direction, a lighting color and a signal type, and the stop line information is managed using a stop line ID associating with a stop line position, a stop line size and a stop line type, and the pairing information is information where the signal location, the signal size, the lighting direction, the lighting color and the signal type which are managed associated with the signal ID, are associated with the stop line position, the stop line size and the stop line type which are managed associated with the stop line ID. Also, in the case where the travelling lane is not identified by the lane identifying unit 9d, the pairing unit 9e pairs the signal information and the stop line information for each road. Further, in the case where the travelling lane is not identified by the lane identifying unit 9d, the pairing unit 9e pairs the signal information and the stop line information at a unit of a road to generate the pairing information. On the other hand, in the case where the traveling lane is identified by the lane identifying unit 9d, the pairing unit 9e pairs the signal information and the stop line information at a unit of the lane identified by the lane identifying unit 9d to generate the pairing information. Note that, even in the case where the travelling lane is identified by the lane identifying unit 9d, the pairing unit 9e may pair the signal information and the stop line information at the unit of a road.

The pairing unit 9e pairs the signal information and the stop line information identified based on the probe data during vehicle-travelling. When the traveling speed of the vehicle is relatively high, the measurement accuracy is relatively high and when the travelling speed of the vehicle is relatively low, the measurement accuracy is relatively low. Hence, the pairing unit 9e treats the signal information and the stop line information acquired based on the probe data when the travelling speed is greater than or equal to a predetermined speed, to be a pairing candidate having relatively high reliability. On the other hand, the pairing unit 9e treats the signal information and the stop line information acquired based on the probe data when the travelling speed is lower than the predetermined speed, to be a pairing candidate having relatively low reliability. That is, in the case where the probe data when the travelling speed is lower than the predetermined speed is excluded, for example, a pairing between the signal information and the stop line information cannot be performed for an intersection where a red-blinking signal or a sensor-type signal is provided requiring a temporary stop under traffic regulations. Accordingly, the pairing unit 9e treats the probe data acquired when the travelling speed is lower than the predetermined speed to be a data having relatively low reliability, and pairs the signal information and the stop line information for such an intersection.

The pairing unit 9e identifies the stop line of the pairing candidate relative to the signal of the pairing candidate in the following manner as a method for identifying a plurality of pairing candidates. As a method executed by the pairing unit 9e for identifying the stop line of the pairing candidate, a method for identifying a stop line of the pairing candidate based on the vehicle location when identifying the signal of the pairing candidate (hereinafter also referred to as first method) and a method for identifying a stop line of the pairing candidate based on the stop line position with respect to the signal of the pairing candidate (hereinafter also referred to as second method) may be used.

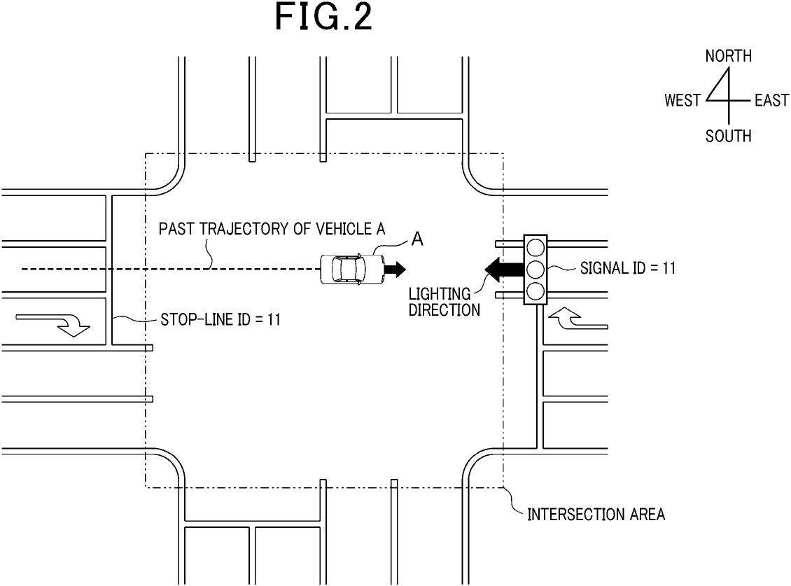

Firstly, with reference to FIGS. 2 to 5, a first method will be described. The signal shown in FIG. 2 or the like in which three display lamps are arranged along a direction orthogonal to the travelling direction of the vehicle refers to a lateral type signal in the real world where the three display lamps are arranged parallel to the horizontal direction with respect to the road surface. The display lamps include a green display lamp, a yellow display lamp and a red display lamp arranged from left to right when viewed in the travelling direction of the vehicle. The green display lamp indicates a permission of entering the intersection area, the yellow display lamp indicates a permission of moving with paying attention to other traffic and the red display lamp indicates prohibition from entering the intersection.

The pairing unit 9e, when the vehicle location at which the signal is identified as a pairing candidate is a location after entering the intersection area, identifies a past vehicle trajectory and identifies a stop line, which the identified past vehicle trajectory crossed, to be the stop line which the vehicle crossed when entering the intersection. Hence, the pairing unit 9e identifies the pairing candidate.

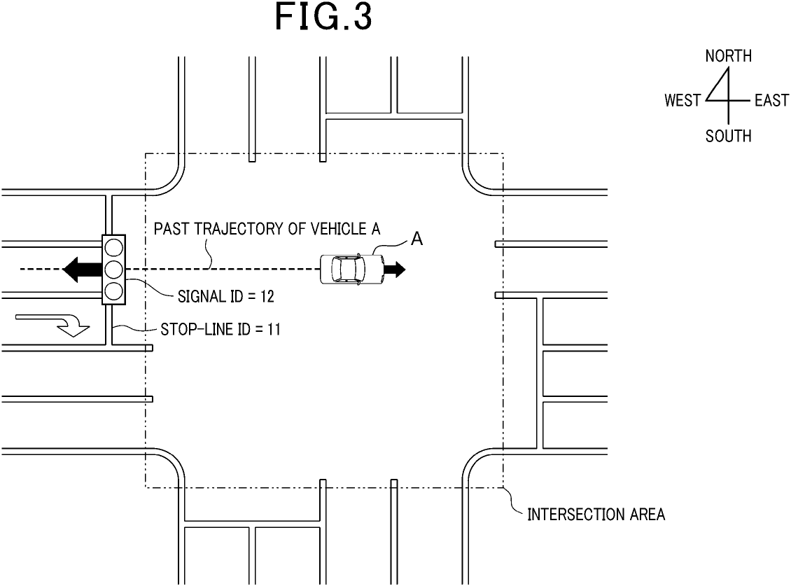

Specifically, as shown in FIG. 2, the pairing unit 9e identifies, with respect to the signal provided at far side of the intersection when viewed in the travelling direction of the vehicle A, a stop line before the intersection, which the past trajectory of the vehicle A crossed, to be the pairing candidate, and pairs the signal information having the signal ID=11 and the stop line information having the stop line ID=11. Similar to a case where the signal is provided before the intersection when viewed in the travelling direction of the vehicle A, as shown in FIG. 3, the pairing unit 9e identifies, with respect to the signal provided at front side of the intersection when viewed in the travelling direction of the vehicle A, a stop line before the intersection, which the past trajectory of the vehicle A crossed, to be the pairing candidate, and pairs the signal information having the signal ID=12 and the stop line information having the stop line ID=11.

In the case where the signal having the signal ID=11 shown in FIG. 2, and a signal having the signal ID=12 shown in FIG. 3 co-exist, the pairing unit 9e may firstly pair the signal information corresponding to the signal ID=11 and the signal information corresponding to the signal ID=12 and subsequently pair the paired signal information having the signals IDs=11 and 12 and the stop line information having the stop line ID=11. That is, in the same intersection, since the lamp states are synchronized for the signal provided at the far side of the intersection when viewed in the travelling direction of the vehicle and the signal provided before the signal, both of these signal information may be paired.

Further, when the vehicle location at which the signal is identified as a pairing candidate is a location before entering the intersection area, the pairing unit 9e identifies the trajectory of the vehicle as a prediction. Then, the pairing unit 9e identifies a stop line at which the identified trajectory of the vehicle crosses, to be a stop line at which the vehicle crosses when entering the intersection as a pairing candidate. In this case, the pairing unit 9e traces the future trajectory ahead of the camera frame where the signal is identified and predicts and identifies the trajectory of the vehicle.

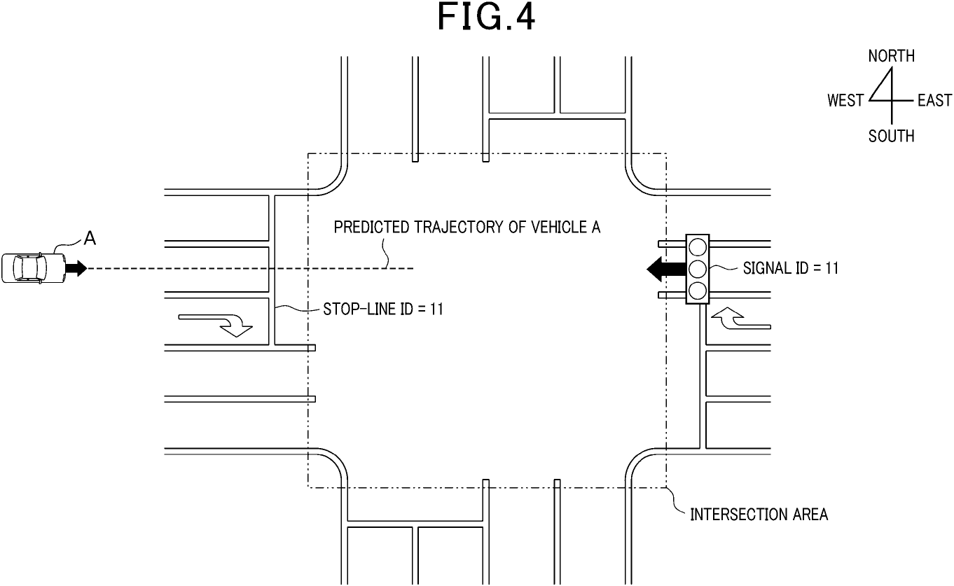

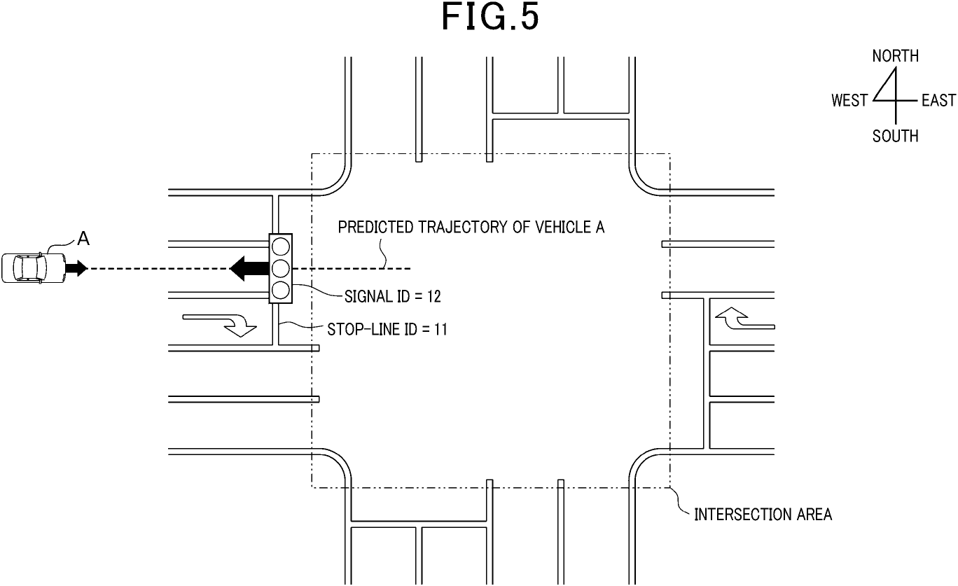

Specifically, as shown in FIG. 4, the pairing unit 9e identifies, with respect to the signal provided at a far side of the intersection when viewed in the travelling direction of the vehicle A, a stop line at which the predicted trajectory of the vehicle A crosses before the intersection to be a pairing candidate, and pairs the signal information having the signal ID=11 and the stop line information having the stop line ID=11. Similar to a case where the signal is provided before the intersection when viewed in the travelling direction of the vehicle A, as shown in FIG. 5, the pairing unit 9e identifies, with respect to the signal provided at a front side of the intersection when viewed in the travelling direction of the vehicle A, a stop line before the intersection which the predicted trajectory of the vehicle A crosses to be the pairing candidate, and pairs the signal information having the signal ID=12 and the stop line information having the stop line ID=11.

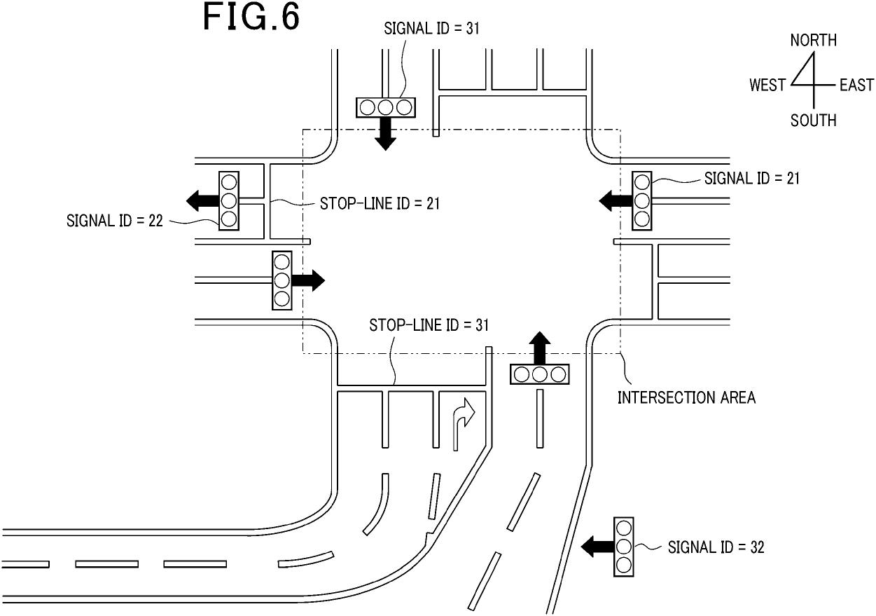

Also, in the case where the signal having the signal ID=11 shown in FIG. 4, and a signal having the signal ID=12 shown in FIG. 6 co-exist, the pairing unit 9e may firstly pair the signal information corresponding to the signal ID=11 and the signal information corresponding to the signal ID=12 and subsequently pair the paired signal information having the signals IDs=11 and 12 and the stop line information having the stop line ID=11. Note that it is possible that the vehicle may change the travelling lane after identifying the stop line which is the pairing candidate. The pairing unit 9e may determine, when the lane with which the trajectory is predicted is different from the lane on which the vehicle travels, a stop line at which the vehicle crosses assuming that the vehicle will travel straight before the vehicle changes lane, to be the pairing candidate.

Moreover, the pairing unit 9e may utilize the lamp state of the signal and the vehicle state, and may determine, when the signal is in green, whether the stop line is present within several meters of radius range with respect to a location at which the signal is identified. The pairing unit 9e may identify a stop line which the trajectory crosses to be the pairing candidate when the stop line is present, and may identify a stop line which the predicted trajectory firstly crosses to be the pairing candidate when the stop line is not present. In other words, with only the location of the signal and the normal vector direction, it may be difficult to identify the stop line as the pairing candidate for a narrow-angle road. However, when utilizing the lamp state of the signal and the vehicle state, the stop line of the pairing candidate can be readily identified.

Moreover, the signal in the real world is disposed such that the lamp direction thereof is visually recognized easily from the object traveling lane and the lamp direction thereof is difficult to recognize from outside the object travelling lane. However, when using the lamp state of the signal, it is determined whether the signal is for the travelling lane of the own vehicle, whereby accuracy for identifying the stop line as the pairing candidate can be improved.

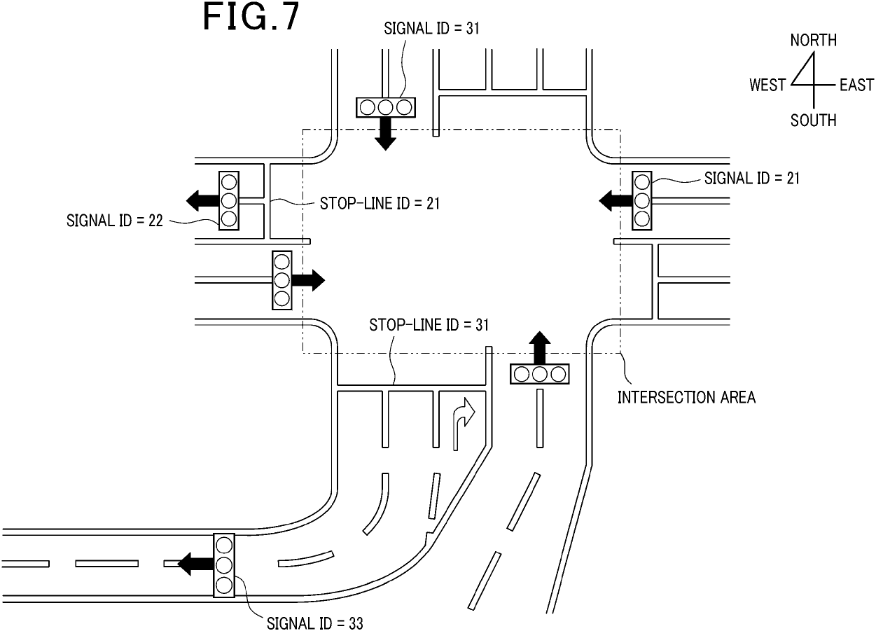

Next, with respect to FIGS. 6 and 7, a second method will be described. The pairing unit 9e identifies, when a stop line is present in an area in a normal vector direction of the signal as a pairing candidate or in an area in an opposite direction with respect to the normal vector direction, the stop line to be the pairing candidate if a distance between the signal as the pairing candidate and the stop line is less than a predetermined distance. On the other hand, the pairing unit 9e identifies, even when a stop line is present in an area towards a normal vector direction of the signal as a pairing candidate or in an area towards an opposite direction with respect to the normal vector direction, the stop line not to be the pairing candidate if a distance between the signal as the pairing candidate and the stop line is greater than or equal to the predetermined distance. The predetermined distance is determined depending on a scale of the intersection, for example, determined by a width of the crossing road, the number of lanes, a width of the lane and the like.

Further, in the case where no stop line is present in an area towards a normal vector direction of the signal as a pairing candidate or in an area towards an opposite direction with respect to the normal vector direction, when a stop line is present in an area towards a travelling direction of the vehicle on a road in the normal vector direction of the signal as the pairing candidate and the distance between the signal as the pairing candidate and the stop line is less than the predetermined distance, the pairing unit 9e identifies the stop line to be the pairing candidate. On the other hand, even in the case where a stop line is present in an area towards a travelling direction of the vehicle on a road in the normal vector direction of the signal as the pairing candidate, if the distance between the signal as the pairing candidate and the stop line is more than or equal to the predetermined distance, the pairing unit 9e identifies the stop line not to be the pairing candidate. The predetermined distance is determined depending on a size of the intersection.

Specifically, as shown in FIG. 6, in the case where a stop line having a stop line ID=21 is present towards the normal vector direction of the signal having the signal ID=21 as the pairing candidate and if the distance between the signal having the signal ID=21 and the stop line having the stop line ID=21 is less than the predetermined distance, the pairing unit 9e identifies the stop line having the stop line ID=21 to be the pairing candidate, and pairs the signal information of the signal ID=21 and the stop line information of the stop line ID=21. Further, in the case where a stop line having a stop line ID=21 is present towards an opposite direction with respect to the normal vector direction of the signal having the signal ID=22 as the pairing candidate and if the distance between the signal having the signal ID=22 and the stop line having the stop line ID=21 is less than the predetermined distance, the pairing unit 9e identifies the stop line having the stop line ID=21 to be pairing candidate and pairs the signal information of the signal ID=22 and the stop line information of the stop line ID=21.

Further, in the case where a stop line having a stop line ID=31 is present towards the normal vector direction of the signal having the signal ID=31 as the pairing candidate and if the distance between the signal having the signal ID=31 and the stop line having the stop line ID=31 is less than the predetermined distance, the pairing unit 9e identifies the stop line having the stop line ID=31 to be the pairing candidate and pairs the signal information having the signal ID=31 and the stop line information having the stop line ID=31.

In the case where no stop line is present within the predetermined distance range towards the normal vector direction of the signal having the signal ID=32 as the pairing candidate and towards the opposite direction with respect to the normal direction, if a stop line having the stop line ID=31 is present towards the travelling direction of the vehicle on a road in the normal vector direction of the signal as the pairing candidate and the distance between the signal having the signal ID=32 and the stop line ID=31 is less than a predetermined distance, the pairing unit 9e identifies the stop line having the stop line ID=31 to be the pairing candidate and pairs the signal information having the signal ID=32 and the stop line information having the stop line ID=31.

In this case, the pairing unit 9e pairs the signal information having the signal IDs=31, 32 and the stop line information having the stop line ID=31. The pairing unit 9e may manage the information according to which lamp state between the signal having the signal ID=31 and the signal having the signal ID=32 is firstly recognized. According to an example shown in FIG. 6, in the case where the vehicle approaches the intersection from the west and makes a turn to enter the intersection, since the vehicle is able to see the signal having the signal ID=32 even before making the left turn, the lamp state of the signal having the signal ID=32 is recognized in advance, and since the vehicle is able to see the signal having the signal ID=31 only after the vehicle approaches the intersection and makes the left turn, the vehicle recognizes the lamp state of the signal having the signal ID=31 after that. The pairing unit 9e firstly pairs the signal information having the signal ID=32 and the stop line information having the stop line ID=31, and then pairs the signal information having the signal ID=31 and the stop line information having the stop line ID=31. The information about the order of the pairings is managed by the server 4 and this information about the order of the pairings is distributed to the on-vehicle equipment, whereby the on-vehicle equipment is able to identify the lamp state of the signal firstly paired with respect to the stop line to which the vehicle approaches. Hence, the vehicle control such as the acceleration-deceleration control can be executed.

Further, as shown in FIG. 7, in the case where no stop line is present within the predetermined distance range towards a normal vector direction of the signal having the signal ID=33 as a pairing candidate or towards an opposite direction with respect to the normal vector direction, if a stop line having the stop line ID=31 is present in an area towards a travelling direction of the vehicle on a road in the normal vector direction of the signal as the pairing candidate and the distance between the signal having the signal ID=33 and the stop line having the stop line ID=31 is less than the predetermined distance, the pairing unit 9e identifies the stop line having the stop line ID=31 to be the pairing candidate, and pairs the signal information having the signal ID=33 and the stop line information having the stop line ID=31.

Also in this case, the pairing unit 9e pairs the signal information having the signal IDs=31, 33 and the stop line information having the stop line ID=31. The pairing unit 9e may manage the information according to which lamp state between the signal having the signal ID=31 and the signal having the signal ID=33 is firstly recognized. With an example shown in FIG. 7, the pairing unit 9e firstly pairs the signal information having the signal ID=33 and the stop line information having the stop line ID=31, and thereafter pairs the signal information having the signal ID=31 and the stop line information having the stop line ID=31.

As aspects of a pairing between the signal information and the stop line information performed by the pairing unit 9e, a pairing in which the signal information and the stop line information are paired with one-to-one basis, a pairing in which the signal information and the stop line information are paired on a one-to-many basis and a pairing in which the signal information and the stop line information are paired with many-to-one basis are present.

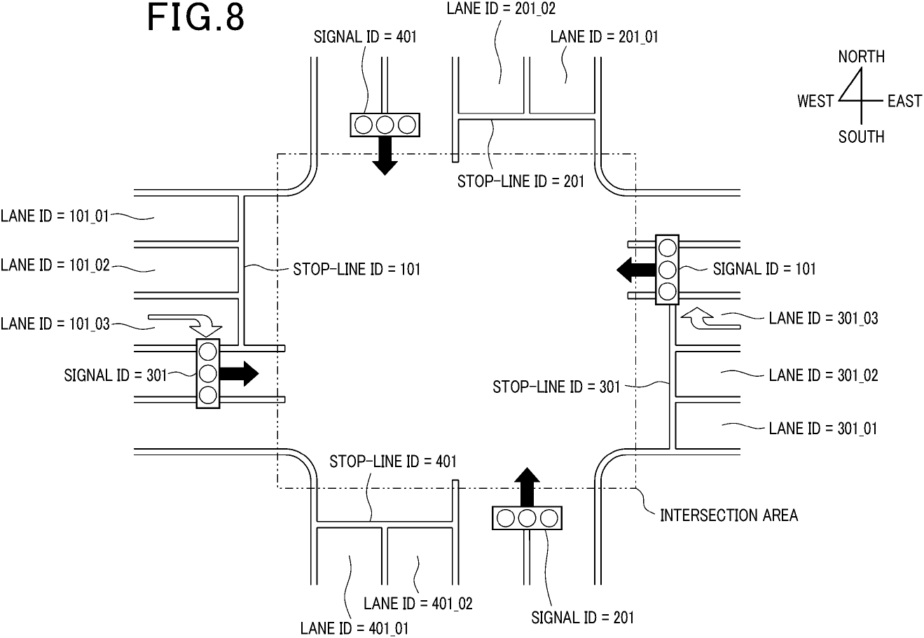

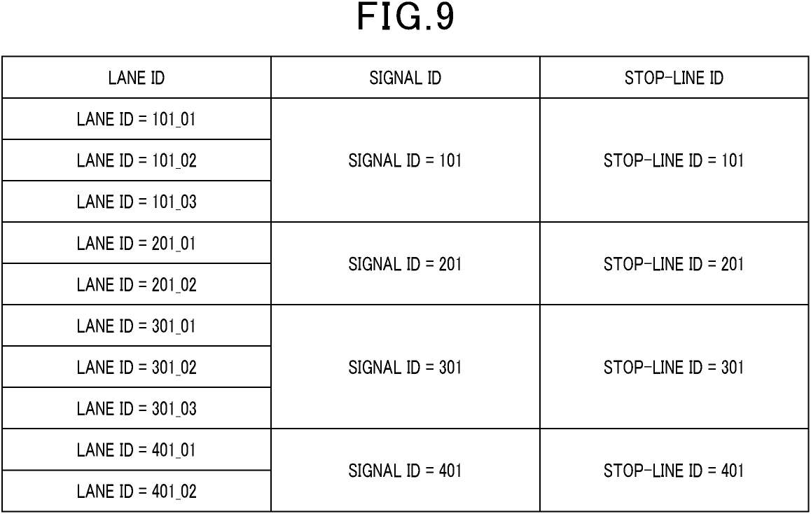

That is, as shown in FIG. 8, a road connected to the intersection from the west side is divided into identified three lanes having lane IDs=101_01, 101_02 and 101_03, a signal having a signal ID=101 is disposed on the road being assigned for the all lanes, and a stop line having a stop line ID=101 is painted on the road surface. With this situation, as shown in FIG. 9, the pairing unit 9e pairs the signal information having the signal ID=101 and the stop line information having the stop line ID=101 for the three lanes having lane IDs=101_01, 101_02 and 101_03.

Similarly, with a road connected to the intersection from the north side, the pairing unit 9e pairs the signal information having the signal ID=201 and the stop line information having the stop line ID=201 for the three lanes having lane IDs=201_01, 201_02 and 201_03. Moreover, with a road connected to the intersection from the east side, the pairing unit 9e pairs the signal information having the signal ID=301 and the stop line information having the stop line ID=301 for the three lanes having lane IDs=301_01, 301_02 and 301_03. Furthermore, with a road connected to the intersection from the south side, the pairing unit 9e pairs the signal information having the signal ID=401 and the stop line information having the stop line ID4301 for the three lanes having lane IDs=401_01, 401_02 and 401_03.

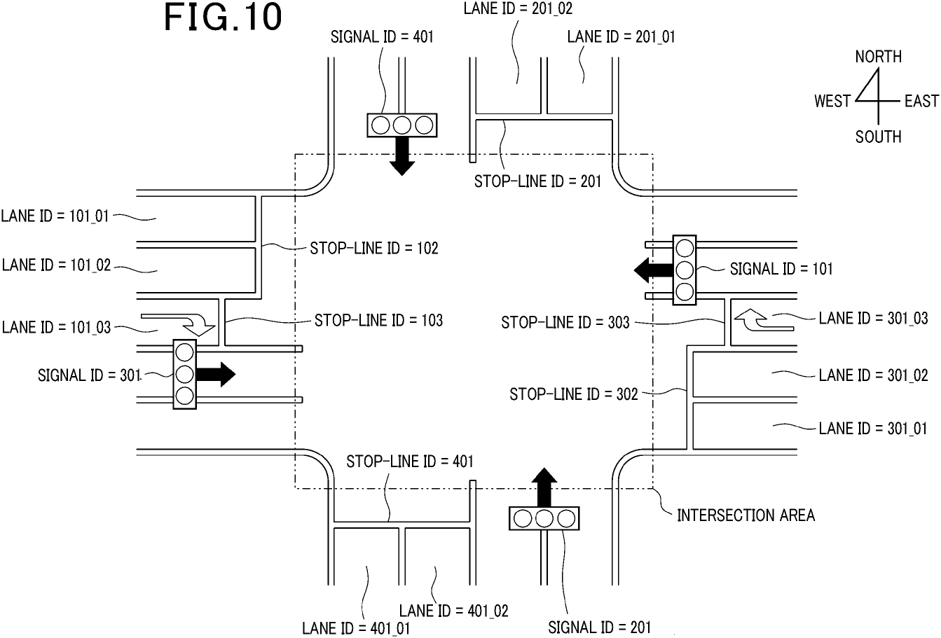

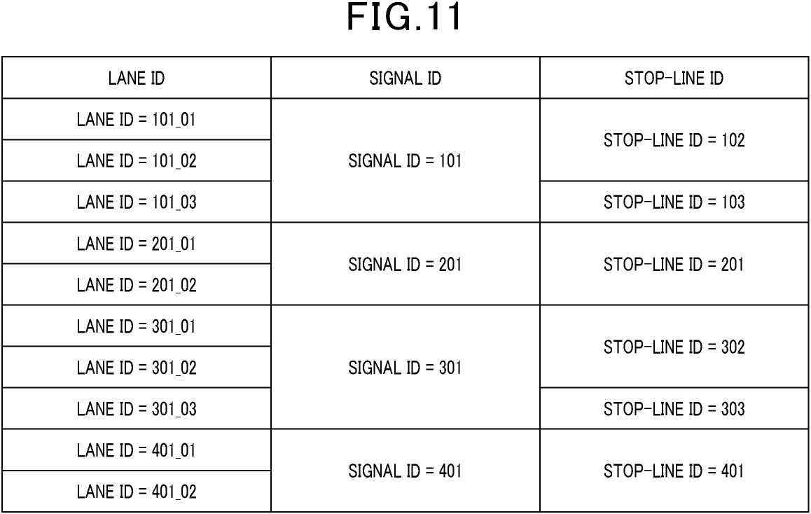

The pairing unit 9e pairs one signal information with different stop line information when positions of the stop lines corresponding to respective parallel lanes are different. As shown in FIG. 10, in the case where a stop line having a stop line ID=102 is painted on the road surface corresponding to two lanes having lane IDs 101_01, 101_02 and a stop line having a stop line ID=103 is painted on the road surface corresponding to a lane having lane ID 101_03 among three lanes of the road connected to the intersection from the west side, as shown in FIG. 11, the pairing unit 9e pairs the signal information having the signal ID=101 and the stop line information having the stop line ID=102 for the two lanes having the lane IDs=101_01 and 101_02, and pairs the signal information having the signal ID=101 and the stop line information having the stop line ID=103 for a lane having the lane ID=101_03.

Similarly, for the road connected to the intersection from the east side, the signal information having the signal ID=301 and the stop line information having the stop line ID=302 are paired for the two lanes having the lane ID=301_01 and 301_02, and the signal information having the signal ID=301 and the stop line information having the stop line ID=303 are paired for the lane having the lane ID=301_03.

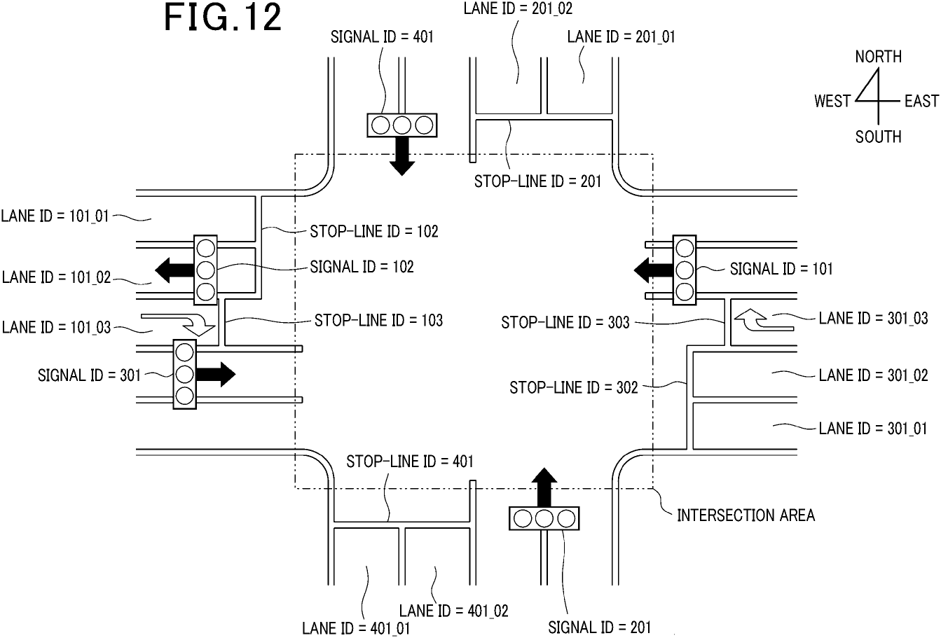

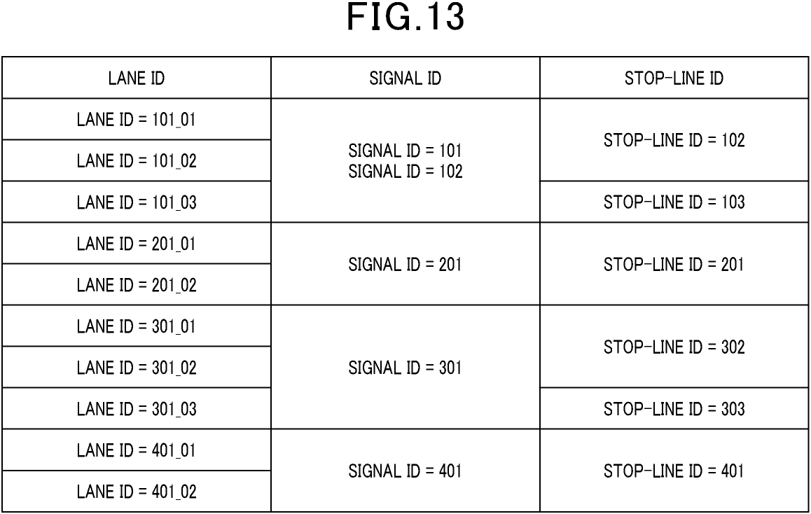

In the case where a plurality of signals are provided for one road, the pairing unit 9e pairs a plurality of pieces of signal information and one stop line information. That is, as shown in FIG. 12, as long as a signal having the signal ID=102 is provided on the road in addition to the signal having the signal ID=101 for the road connected to the intersection from the west side, as shown in FIG. 13, the pairing unit 9e pairs the signal information having the signal IDs=101 and 102 and the stop line information having the stop line ID=102 for the two lanes having the lane-ID=101_01 and 101_02 and pairs the signal information having the signal IDs=101 and 102 and the stop line information having the stop line ID=103 for one lane having the lane-ID=101_03.

Also in this case, the pairing unit 9e may manage the information according to which lamp state between the signal having the signal ID=101 and the signal having the signal ID=102 is firstly recognized. According to an example shown in FIG. 12, since the distance from the vehicle to the signal having the signal ID=101 disposed in the front side of the intersection is relatively short and the distance from the vehicle to the signal having the signal ID=101 disposed at far side of the intersection is relatively long, the lamp state of the signal having the signal ID=102 is firstly recognized and then the lamp state of the signal having the signal ID=101 is recognized. The pairing unit 9e firstly pairs the signal information having the signal ID=102 and the stop line information having the stop line ID=102 and thereafter pairs the signal information having the signal ID=101 and the stop line information having the stop line ID=102.

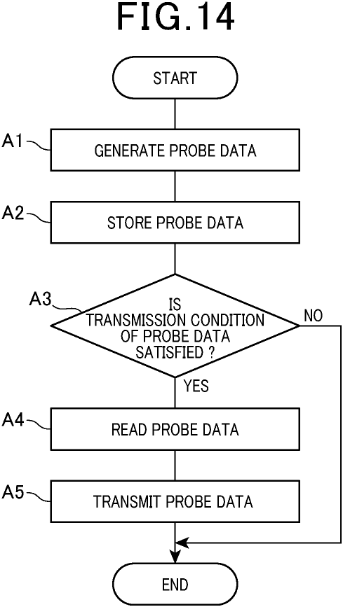

Next, with reference to FIGS. 14 to 23, effects and advantages of the above-described configuration will be described. Here, as a process executed by the on-vehicle equipment 2, a probe data transmission process will be described, as a process executed by the server 3, a probe data reception process, a pairing information generation process with a provisional pairing and a pairing information generation process without a provisional pairing will be described. According to the pairing information generation process with a provisional pairing, the above-described first method is utilized as a method for identifying a pairing candidate to identify the stop line of the pairing candidate. According to the pairing information generation process without a provisional pairing, the above-described second method is utilized as a method for identifying a pairing candidate to identify the stop line of the pairing candidate. Note that the server 3 executes a map generation program, thereby executing the probe data reception process, the pairing information generation process with the provisional pairing and the pairing information generation process without the pairing information generation process.

### Probe Data Transmission Process (See FIG. 14)

In the on-vehicle equipment 2, the control unit 5 repeatedly executes, at every predetermined period, a probe data transmission process that generates the probe data during the ignition being turned ON. The control unit 5 starts executing the probe data transmission process when a start event of the probe data transmission process is satisfied, generates probe data (A1) from surrounding information, travelling information and positional information and causes a probe data storage unit 7 to store (A2) the probe data. The control unit 5 determines whether a transmission condition of the probe data is satisfied (A3), terminates the probe data transmission process when determined that the probe data transmission condition is not satisfied (A3: NO), and waits for the start event of the next probe data transmission process.

The control unit 5, when determined that the transmission condition of the probe data is satisfied (A3: YES), reads the probe data (A4) stored in the probe data storage unit 7, causes the data communication unit to transmit the read probe data to the server 3 (A5), terminates the probe data transmission process and waits for the start event of the next probe data transmission process.

Specifically, with a transmission condition of the probe data as a lapse of a predetermined period, the control unit 5 causes the data communication unit 6 to transmit the probe data to the server 3 every time when the predetermined period elapses, and with a transmission condition of the probe data where the travel distance of the vehicle reaches a predetermined distance, the control unit 5 causes the data communication unit 6 to transmit the probe data to the server 6 every time the travel distance of the vehicle reaches the predetermined distance. The control unit 5 may utilize a transmission condition in which it is determined that signal data is present in a camera image using an image analysis of the camera image. In this case, the control unit 5 may cause the data communication unit 6 to transmit the probe data including the signal data every time it is determined that signal data is present in the camera image to the server 3.

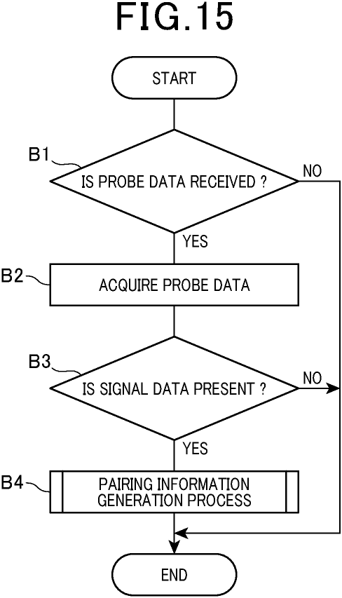

### Probe Data Reception Process (See FIG. 15)

In the server 3, the control unit 9 repeatedly executes, at every predetermined period, a probe data reception process that receives the probe data from the vehicle. The control unit 9 starts the probe data reception process when the start event of the probe data reception process is satisfied and determines whether the data communication unit 10 receives the probe data transmitted from the on-vehicle equipment 2 (B1). The control unit 9 terminates the probe data reception process when determined that the probe data is not received by the data communication unit 10 (B1:NO), and waits for the start event of the next probe data reception process.

The control unit 9 acquires the probe data (B2, corresponding to probe data acquiring process) when determined that the data communication unit 10 receives the probe data (B1: YES) and determines whether signal data indicating a signal is present in the acquired probe data (B3). When determined that no signal is present in the probe data (B3:NO), the control unit 9 terminates the probe data reception process and waits for the start event of the next probe data reception process.

The control unit 9 proceeds to a pairing information generation process (B4) when determined that signal data is present in the probe data (B3:YES). The control unit 9 executes, as a pairing information generation process, any one of processes among a pairing information generation process with provisional pairing, or a pairing information process without provisional pairing. Hereinafter, a pairing information generation process with a provisional pairing and a pairing information generation process without a provisional pairing will be sequentially described. Note that the control unit 9 returns to the probe data reception process when terminating the pairing information generation process and terminates the probe data reception process and waits for the start event of the next probe data reception process.

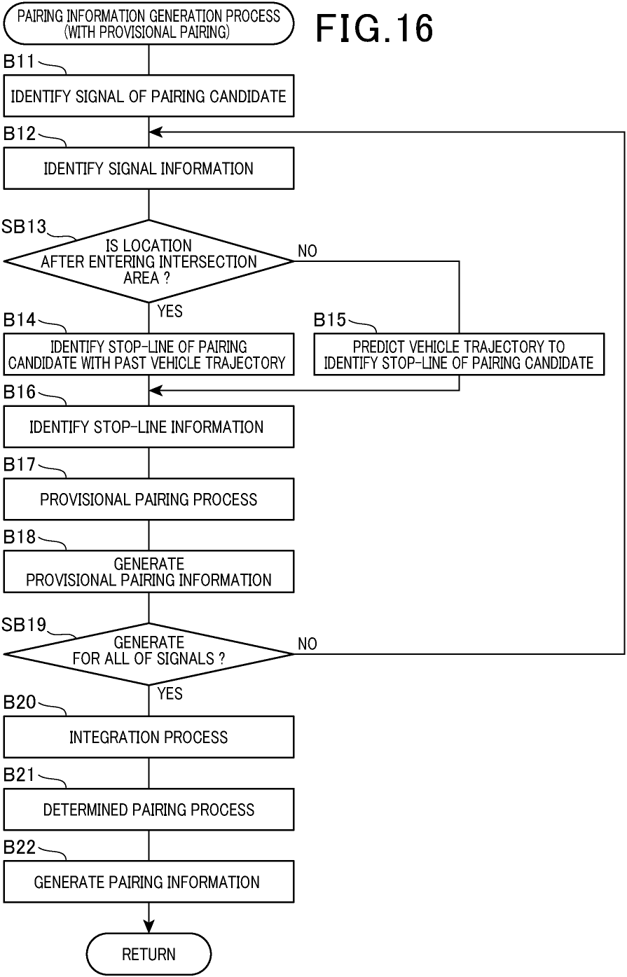

### 1) Pairing Information Generation Process With a Provisional Pairing (See FIG. 16)

The control unit 9 identifies a signal as a pairing candidate from the signal data in the probe data when starting the pairing information generation process with a provisional pairing (B11). That is, when the signal data indicates one signal, the control unit 9 determines this one signal to be a pairing candidate, and when the signal data indicates a plurality of signals, the control unit 9 determines the plurality of signals to be pairing candidates, thereby identifying the signal as a pairing candidate.

The control unit 9 identifies, based on the probe data, the signal information for the identified signal as the pairing candidate (B12, corresponding to signal information identifying process). That is, the control unit 9 applies the signal ID to the signal as the pairing candidate, and a signal location, a signal size, a lighting direction, a lighting color and a signal type are associated with the signal ID applied to the signal, thereby identifying the signal information.

Next, the control unit 9 determines whether the vehicle location at which the signal is identified as the pairing candidate is a location after entering the intersection (B13). When identifying that the vehicle location at which the signal is identified as the pairing candidate is a location after entering the intersection (B13:YES), since the vehicle already passes across the stop line, the control unit 9 identifies the stop line as the pairing candidates using the past trajectory of the vehicle (B14). On the other hand, when determined that the vehicle location at which the signal is identified as a pairing candidate is a location before entering the intersection area not a location after entering the intersection area (B13: NO), since the vehicle does not pass across the stop line, the control unit 9 predicts the trajectory of the vehicle and identifies the stop line of the pairing candidate (B15).

Next, the control unit 9 identifies the stop line information based on the probe data for the identified stop line as the pairing candidate (B16, corresponding to stop line information identifying process). That is, the control unit 9 applies the stop line ID to the stop line of the pairing candidate, and a stop line position, a stop line size and a stop line type are associated with the stop line ID applied to the stop line, thereby identifying the stop line information.

Subsequently, the control unit 9 executes a provisional pairing process for provisionally pairing the identified signal information and the stop line information (B17), and generates provisional pairing information (B18, corresponding to pairing information generation process). The control unit 9 determines whether the provisional pairing information has been generated for all of the identified signals as the pairing candidates (B19). The control unit 9 returns to step B12 when determined that the provisional pairing information has not been generated for all of the identified signals as the pairing candidates (B19: NO), and repeats processes from step B12 and latter processes.

The control unit 9 executes an integration process that integrates a plurality of probe data (B20) when determined that the provisional information is generated for all of the identified signals as the pairing candidates (B19: YES). The integration process receives and collects probe data transmitted from a plurality of vehicles, correlates positional information and attribute information of objects based on the collected probe data to enhance the positional accuracy and the attribute accuracy, thereby generating the map data. The attribute information refers to information indicating a type of lane marking (solid line, dotted line and the like), or the color (white or yellow). That is, in the integration process, the control unit 9 identifies, based on the probe data, the signal and the stop line as the object, correlates the positional information and the attribute information for the identified signal and the stop line to enhance a positional accuracy and the attribute accuracy of the signal and the stop line. With the integration process thus executed, the control unit 9 is able to reduce possibility of erroneous identification where one signal in the real world is identified as different signals.

The control unit 9 applies a statistical process to the provisional pairing information based on the result of the integration process so as to perform a determined pairing process (B21) in which the signal information and the stop line information are paired as determined pair, generates the pairing information (B22, corresponding to pairing information generation process), and terminates the pairing information generation process with the provisional pairing.

According to the provisional pairing process before performing the integration process, since the signal information and the stop line information are paired for each probe data, the number of probe data items used for pairing the signal information and the stop line information is 1. Hence, there is not sufficient reliability for the signal information and the stop line information. In other words, since the pairing is performed in a state where the signal location, the signal size, the lighting direction, the lighting color, the signal type, the stop line position, the stop line size and the stop line type are not able to be matched, and it is possible to erroneously pair the signal information and the stop line information and lower the accuracy of the pairing. However, according to the above-described pairing information generation process with a provisional pairing, an integration process is performed after the provisional pairing process, and a statistical process is performed after the integration process for the provisional information generated by the provisional pairing process based on a result of the integration process. Then, the signal information and the stop line information are paired as a determined pair. Accordingly, the accuracy of the pairing can be enhanced.

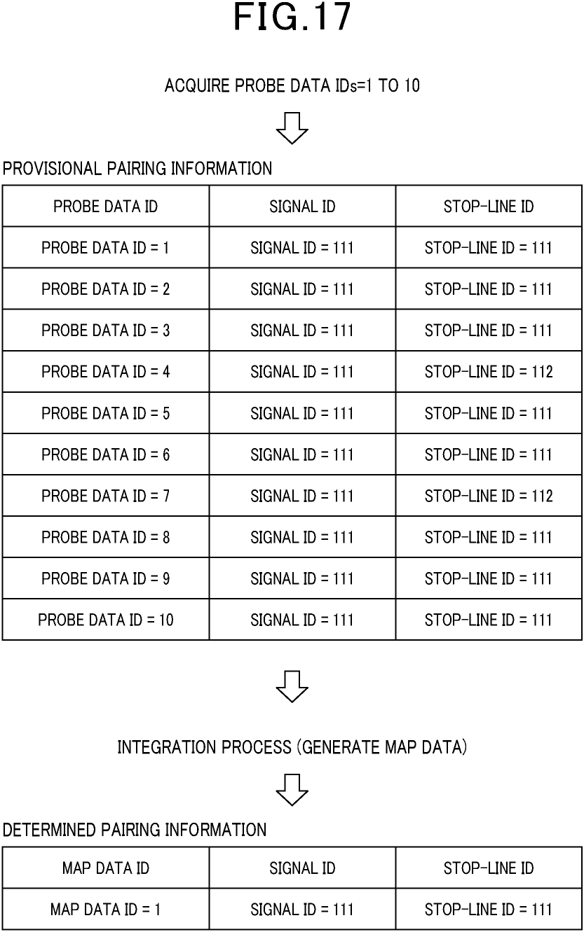

As shown in FIG. 17, the control unit 9 generates 8 pieces of provisional pairing information where the signal information having the signal ID=111 and the stop line information having the stop line ID=111 are paired for 10 probe data items having probe data IDs=1 to 10. In the case where 2 pieces of provisional pairing information is generated, each provisional pairing information being paired information of signal information having the signal ID=111 and the stop line information having the stop line ID=112, the control unit 9 executes the statistical process based on the result of the integration process, determines that the pairing of the signal information having the signal ID=111 and the stop line information having the stop line ID=111 is probable and pairs, as the determined pair, the signal information having the signal ID=11 and the stop line information having the stop line ID=111. Since the probe data ID is no longer maintained once the integration process is performed, a map ID of the map data generated by the integration process is applied.

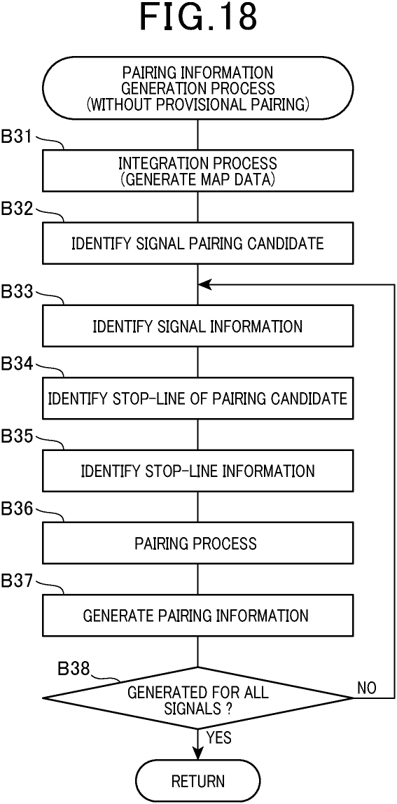

### 2) Pairing Information Generation Process Without Provisional Pairing (See FIG. 18)

The control unit 9 executes an integration process for integrating a plurality of probe data when the pairing information generation process without a provisional pairing is started (B31). That is, the control unit 9 correlates the positional information and the attribute information for the signal and the stop line before pairing the signal information and the stop line information, and enhances the positional accuracy and the attribute accuracy to generate the map data.

Next, the control unit 9 identifies a signal as a pairing candidate among the signal data in the map data generated in the integration process (B32). That is, the control unit 9 identifies one signal as a pairing candidate when the signal data indicates one signal and identifies a plurality of signals as pairing candidates when the signal data indicates a plurality of signals.

The control unit 9 identifies signal information based on the probe data for the identified signal as the pairing candidate (B33, corresponding to signal information identifying process). The control unit 9 applies the signal ID to the signal as the pairing candidate, and a signal location, a signal size, a lighting direction, a lighting color and a signal type are associated with the signal ID applied to the signal, thereby identifying the signal information.

Next, the control unit 9 identifies a stop line as a pairing candidate from the positional information and the attribute information of the signal (B34). The attribute information of the signal is a normal vector direction, for example. When the signal is present at the far side of the intersection, the control unit 9 identifies a stop line before the intersection in the normal vector direction of the signal to be the stop line as the pairing candidate. When the signal is present before the intersection, the control unit 9 identifies a stop line which is present in a front side or a far side of the signal in the normal vector direction thereof to be a pairing candidate.

Subsequently, the control unit 9 identifies, based on the probe data, a stop line information for the identified stop line as the pairing candidate (B35, corresponding to stop line information identifying process). The control unit 9 applies the stop line ID to the stop line of the pairing candidate, and a stop line position, a stop line size and a stop line type are associated with the stop line ID applied to the stop line, thereby identifying the stop line information.

Next, the control unit 9 performs a pairing process that pairs the identified signal information and the stop line information (B36) and generates the pairing information (B37, corresponding to pairing information generation process). The control unit 9 determines whether the pairing information is generated for all of the identified signals as the pairing candidates (B38). The control unit 9 returns to step B33 when determined that the pairing information is not generated for all of the signals identified as the pairing candidates (B39: NO), and repeatedly executes the process at step B33 and later processes.

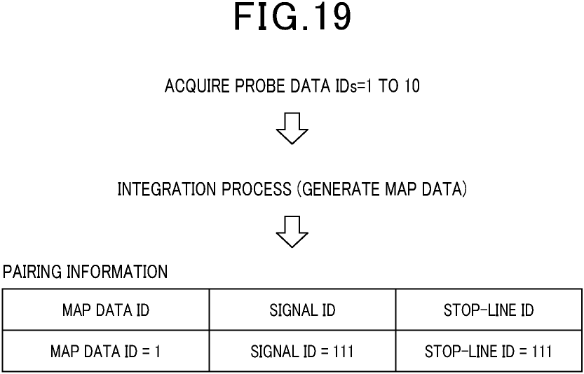

The control unit 9 terminates the pairing information generation process without the provisional pairing when determined that the pairing information is generated for all of the signals identified as the pairing candidates (B39: YES). As shown in FIG. 19, the control unit 9 pairs the signal information having the signal ID=111 and the stop line information having the stop line ID=111 for 10 probe data having the probe data ID=1 to 10 after performing the integration process. Also in this case, the probe data ID is no longer maintained once the integration process is performed, a map ID of the map data generated by the integration process is applied.

According to such a pairing information generation process without the provisional pairing, unlike the above-described pairing information generation process with a provisional pairing, since the pairing is performed in a state where the signal size, the lighting direction, the lighting color, the signal type, the stop line position, the stop line size and the stop line type are converged, probability of erroneous pairing between the signal information and the stop line information can be reduced.

Further, compared to the pairing information generation process that requires 2 step processes of a provisional pairing process and a determined pairing process as a pairing process, the pairing information generation process without the provisional pairing requires only one pairing process.

Further, the control unit 9 may select the pairing candidate based on the reliability of the probe data to identify object pairing candidate, when pairing the signal information and the stop line information. As the reliability of the probe data, a positional reliability and a recognition reliability can be utilized, for example. The positional reliability is an index indicating whether the absolute position or a relative position is stably measured. The positional reliability is influenced by a presence or an absence of a rapid positional change due to a sideslip or a vibration, or a presence or an absence of a shielding object that influences a measurement of the positional information. In other words, when no sideslip or no rapid positional change is present, or no shielding object that influences the measurement of the positional relationship is present, the positional reliability is relatively high. When a sideslip or a rapid positional change is present, or a shielding object that influences the measurement of the positional relationship is present, the positional reliability is relatively low. The recognition reliability is an index indicating whether object data is stably recognized and expressed by an illuminance in the vicinity of the vehicle, a weather, a presence or an absence of a preceding vehicle and the like. In the case where the illuminance in the vicinity of the vehicle is appropriate or the weather indicates that it is sunny or no preceding vehicle is present, the recognition reliability is relatively high. Moreover, if the illuminance in the vicinity of the vehicle is inappropriate, or the weather is poor such as rain or snow, or a preceding vehicle is present, the recognition reliability is relatively low. As the reliability of the probe data, other than the above-described positional reliability and the recognition reliability, a reliability based on information generated when recognizing SFM (i.e. structure from motion), information generated when detecting an object, information generated when estimating the road slope, information generated when estimating the sensor visibility and the like can be utilized.

Specifically, the control unit 9 makes the probe data correspond to the reliability and may pair the signal information and the stop line information identified in accordance with the probe data having a reliability larger than a predetermined level. In this case, the server 3 may determine the reliability of the probe data transmitted from the on-vehicle equipment 2 and select the probe data to be used for generating the signal information and the stop line information. Moreover, the on-vehicle equipment 2 may determine the reliability of the probe data generated from the vicinity information, the travelling information and the positional information and select the probe data to be used for generating the signal information and the stop line information.

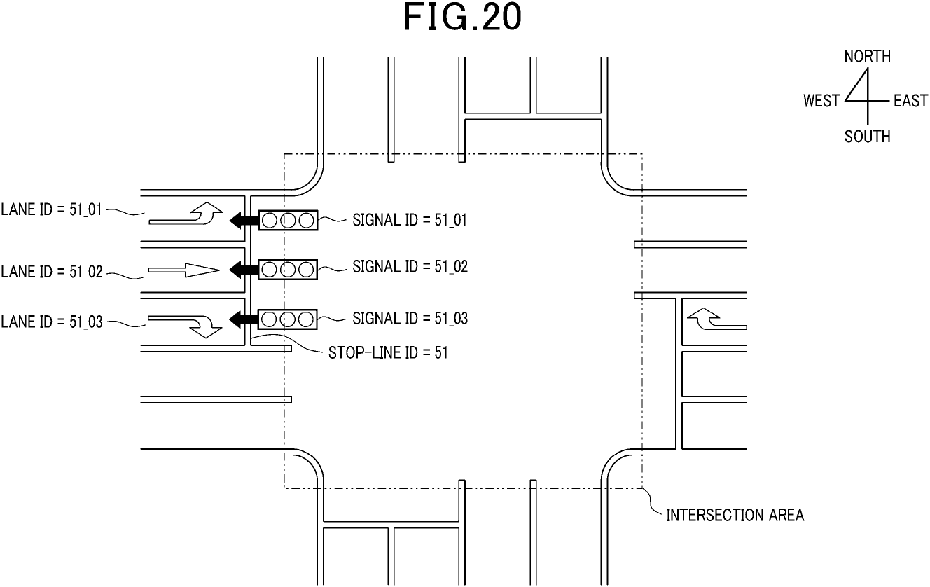

For a shape of signal, a vertical type signal may be present other than the above-described lateral type signal. In FIG. 20, a signal having 3 lamps arranged in the travelling direction of the vehicle refers to a vertical type signal in which 3 lamps are vertically arranged relative to the road surface in the real world. This vertical type signal is provided with a lamp (green lamp) indicating a permission of entering the intersection area, a lamp (yellow lamp) indicating a permission of moving with paying attention to other traffic and a lamp (red lamp) indicating prohibition from entering the intersection arranged in this order from the lower side to the upper side when viewed from the travelling direction of the vehicle. Even in this case where such a vertical type signal is provided, the pairing unit 9e pairs the signal information and the stop line information for each lane.

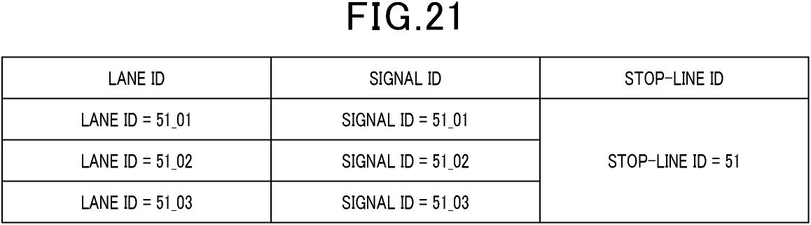

As shown in FIG. 20, in the case where the signal is provided for each lane, the pairing unit 9e pairs the signal information and the stop line information for each lane when the signal is provided for each lane and generates the pairing information. Specifically, as shown in FIG. 21, the pairing unit 9e pairs the signal information having the signal ID=51_01 and the stop line information having the stop line ID=51 for the left-turn lane having the lane-ID=51_01, pairs the signal information having the signal ID=52 and the stop line information having the stop line ID=51 for the straight lane having the lane-ID=51_02, and pairs the signal information having the signal ID=51_03 and the stop line information having the stop line ID=51 for the right-turn lane having the lane-ID=51_03, thereby generating the pairing information.

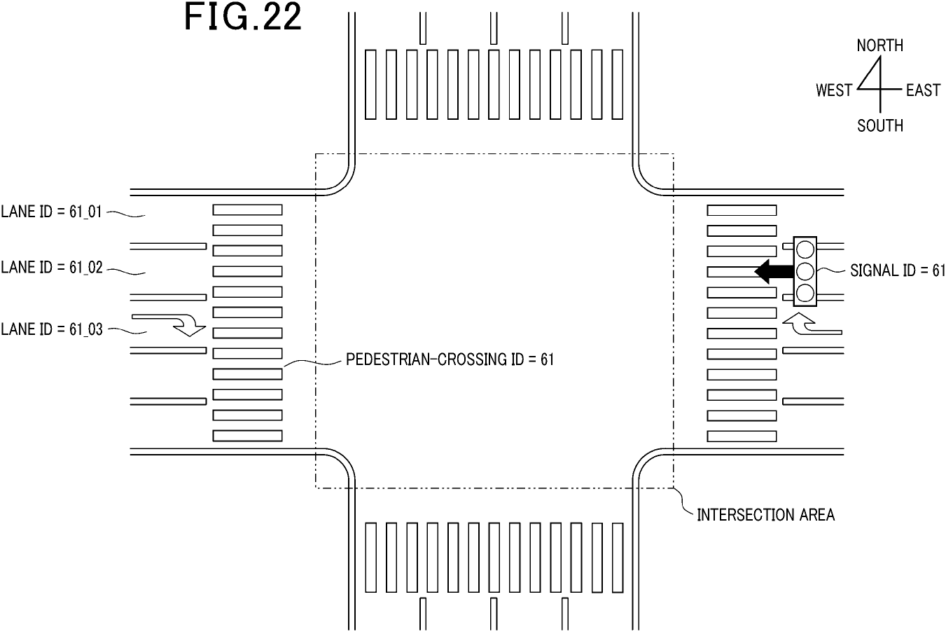

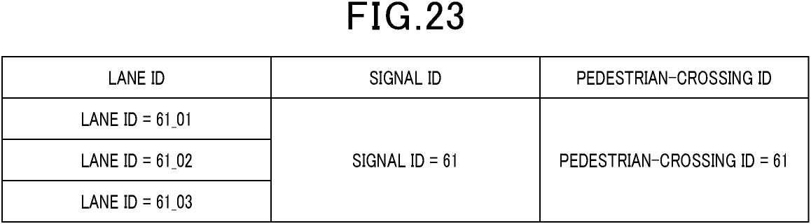

Further, as shown in FIG. 22, a pedestrian-crossing which is not a stop line is sometimes painted. In this case, the stop line information identifying unit 9e identifies pedestrian-crossing information related to the pedestrian crossing in the intersection based on the probe data acquired by the probe data acquiring unit 9a, instead of identifying the stop line information, and treats the identified pedestrian-crossing information as the stop line information. The pedestrian-crossing information is managed associated with a pedestrian-crossing ID capable of identifying the pedestrian-crossing, and managed associated with a pedestrian-crossing position capable of identifying the position of the pedestrian-crossing, a pedestrian-crossing size capable of identifying the pedestrian-crossing size and a pedestrian-crossing type capable of identifying the type of the pedestrian-crossing. The pedestrian-crossing position is expressed by three-dimensional coordinates. The pedestrian-crossing size is expressed by a positional coordinate of the center of the pedestrian-crossing, a positional coordinate of the end point, a dimension of the width direction (road width direction) and a dimension of the depth direction (lane-marking direction). The pedestrian-crossing type is defined by presence or absence of the stop line parallel to the pedestrian-crossing. Specifically, as shown in FIG. 23, the pairing unit 9e pairs the signal information having the signal ID=61 and the pedestrian information having the pedestrian-crossing ID=61 for 3 lanes having lane IDs=61_01, 61_02 and 61_03 and generates the pairing information.

In the server 3, the control unit 9 updates the map data using the pairing information thus generated, and causes the map data storage unit 12 to store the map data containing the updated map data. Hence, the map data containing the updated map data be managed. Also, the control unit 9 causes the data communication unit 10 to distribute the map data containing the updated map data to the on-vehicle equipment 2, whereby the map data where the signal information and the stop line information are paired can be provided to the vehicle.

In the on-vehicle equipment 2, when the data communication unit 6 receives the map data transmitted from the server 3, the control unit 5 is able to perform travelling control using the pairing information included in the received map data. That is, the control unit 5 refers to the pairing information when detecting a signal from a camera image to identify the stop line information which is paired with the detected signal information of the signal, thereby calculating the position at which the own vehicle should be stopped and performing a deceleration support depending on the situation. As long as the vehicle is configured as an autonomous driving vehicle, the vehicle is able to perform travelling control to control the vehicle to stop before the stop line. Therefore, safety and security can be ensured for vehicle driving operation. Further, even in the case where the position of the signal or the stop line cannot be accurately identified because of poor conditions such as nighttime-driving, rain falling, backlight condition and the like, the positions of the signal and the stop line can be accurately identified by referring to the map data where the pairing information is reflected. Further, when identifying a plurality of signals, it can determine which signal corresponds to the travelling lane.

Next, processes of the on-vehicle equipment 2 will be described. In the server 3, the above-described series of processes are executed, thereby pairing the signal information and the stop line information to generate the pairing information. However, not only because of the above-described bad condition such as the nighttime-driving, rain falling, backlight condition and the like, but also because of various reasons, the signal information and the stop line information may be erroneously paired. Also, in the case where a plurality of roads are provided to be in parallel, it is possible to erroneously pair the signal information and the stop line information. In contrast, the on-vehicle equipment 2 determines whether the pairing information distributed from the server 3 is correct or incorrect. As a method for determining whether the pairing information is correct or incorrect, a method for determining based on the lamp state of the signal and a method for determining based on the trajectory of the vehicle are present. Hereinafter, respective methods will be described.

The on-vehicle equipment 2 stores the map data including the pairing information distributed from the server 3 to the map data storage unit 8 and acquires the stored pairing information to determine whether the pairing information is correct or incorrect. The on-vehicle equipment 2 may determine whether the pairing information is correct either during a trip or after a trip. The on-vehicle equipment 2 determine, during the trip, whether the pairing information where the signal information and the stop line information are paired every time when the vehicle passes the stop line provided with the signal. The on-vehicle equipment 2 acquires, after the trip, a history of the vehicle passing through the stop line provided with the signal based on the trajectory, and analyzes the acquired history, thereby determining whether the pairing information in which the signal information and the stop line information are paired is correct or incorrect. That is, the on-vehicle equipment 2 may determine whether the pairing information is correct or incorrect during the trip in a real-time manner, or determine whether the pairing information is correct or incorrect after the trip in a non-real time manner. Hereinafter, a case of determining whether the pairing information is correct or incorrect during the trip in a real time manner will be described.

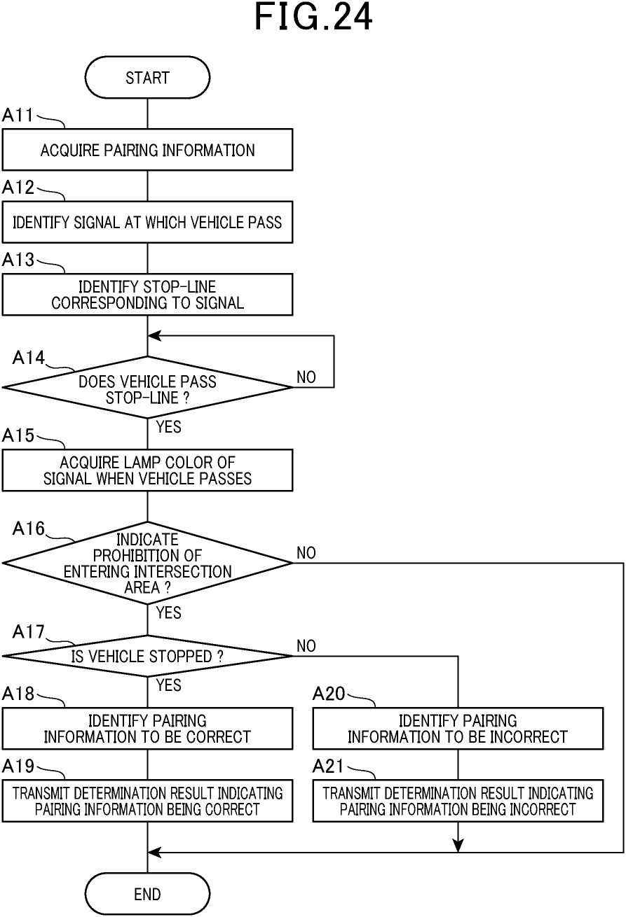

### 1) Pairing Correctness Determination Process Based on a Lamp State of Signal (See FIG. 24)

In the on-vehicle equipment, the control unit 5 acquires the pairing information included in the map data when a start event of the pairing correctness determination process is satisfied (A11). The control unit 5 identifies the signal where the vehicle passes based on the probe data generated from the vicinity information, the travelling information and the positional information (A12) and identifies the stop line corresponding to the identified signal (A13).

The control unit 5 determines whether the vehicle to which the on-vehicle equipment 2 is mounted passes the stop line (A14). The control unit 5 acquires, when determined that the vehicle passes the stop line (A14:YES), the lamp color of the signal when the vehicle passes the stop line based on the camera image in the travelling direction of the vehicle captured by the on-vehicle camera (A15).

The control unit 5 determines whether the lamp color of the signal when the vehicle passes the stop line indicates prohibition from entering the intersection area (A16). In this case, the control unit 5 determines not only the color indicating prohibition from entering the intersection but also determines whether a right-turn permission or a left-turn permission is present. The control unit 5 determines whether the vehicle is stopped (A17), when determined that the lamp of the signal when the vehicle passes the stop line indicates prohibition from entering the intersection (A16: YES).

The control unit 5, when determined that the vehicle is stopped (A17: YES), identifies that the pairing information of the signal information and the stop line information of the signal is correct (A18), causes the data communication unit 6 to transmit the determination result indicating that the pairing information is correct to the server 3 (A19), terminates the probe data transmission process and waits for the start event of the next probe data transmission process.

On the other hand, the control unit 5, when determined that the vehicle is not stopped (A17: NO), identifies the pairing information of the signal information of the signal and the stop line information of the stop line is incorrect(A20), causes the data communication unit 6 to transmit the determination result indicating that the pairing information is incorrect to the server 3 (A21), terminates the probe data transmission process, and waits for the start event of the next probe data transmission process.

Further, the control unit 5, when determined that the lamp color when the vehicle passes the stop line does not indicate prohibition from entering the intersection but indicates permission of entering the intersection area or a permission of moving with paying attention to other traffic (A16:NO), terminates the pairing correctness determination process without determining whether the pairing between the signal information of the signal and the stop line information of the stop line is correct or incorrect, and waits the start event of the next pairing correctness determination process.

In the above-description, when determined that the lamp color of the signal when the vehicle passes the stop line indicates prohibition from entering the intersection and the vehicle is not stopped, the pairing information between the signal information of the signal and the stop line information of the stop line is determined to be incorrect. However, when determined that the lamp color of the signal when the vehicle passes the stop line indicates a permission of entering the intersection area and the vehicle does not pass the intersection, the pairing information between the signal information of the signal and the stop line information of the stop line may be determined to be incorrect. In this case, if preceding vehicles form a traffic jam ahead of the signal in the real world, since the vehicle cannot pass the intersection, it is preferrable to determine the pairing information considering traffic information acquired from a road traffic information communication system (VICS (vehicle information and communication system) (registered trade mark)), inter-vehicle communication, or road-vehicle communication.

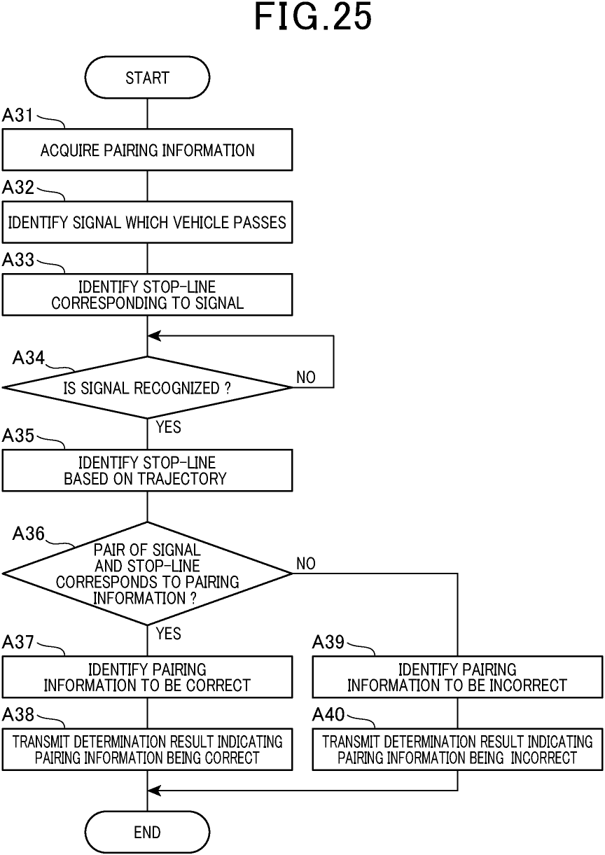

### 2) Pairing Correctness Determination Process Based on Trajectory of Vehicle (See FIG. 25)

In the on-vehicle equipment 2, the control unit 5 acquires the pairing information generated by the server 3 (A31) when a start event occurs for determining whether the pairing correctness determination process is satisfied. The control unit 5 identifies a signal where the vehicle passes based on the probe data generated from the traveling information and the positional information (A32) and identifies the stop line corresponding to the signal (A33).

The control unit 5 determines whether the signal is recognized based on the camera image in the travelling direction of the vehicle captured by the on-vehicle camera (A34). The control unit 5, when determined that the signal is recognized (A34: YES), determines the stop line based on the trajectory of the vehicle to which the on-vehicle equipment 2 before and after recognizing the signal (A35). The control unit 5 determines whether the pair of the recognized signal and the identified stop line corresponds to the pairing information (A36).

The control unit 5, when determined that the pair between the recognized signal and the identified stop line corresponds to the pairing information (A36: YES), identifies that the pairing information between the signal information of the signal and the stop line information of the stop line is correct (A37), causes the data communication unit 6 to transmit the determination result indicating that the pairing information is correct to the server 3 (A38), terminates the probe data transmission process and waits for the start event of next probe data transmission process.

On the other hand, when determined that the pair between the recognized signal and the identified stop line does not correspond to the pairing information (A36: NO), the control unit 5 identifies that the pairing information between the signal information of the signal and the stop line information of the stop line is incorrect (A39), causes the data communication unit 6 to transmit the determination result indicating that the pairing information is incorrect to the server 3 (A40), terminates the probe data transmission process and waits for the start event of next probe data transmission process.

When receiving the determination result thus determined whether the pairing information transmitted from the on-vehicle equipment 2 is correct or incorrect, the server 3 verifies the pairing information based on the determination result. In the case where a plurality of on-vehicle equipment 2 transmits the determination result indicating that the pairing information is incorrect and the number of determination results is greater than or equal to a threshold, the server 3 invalidates the pairing information and distributes information that the pairing information is invalid to the on-vehicle equipment 2, whereby erroneous travelling control caused by referring erroneous pairing information can be prevented from being executed in advance.

According to the present embodiment as described above, the following advantageous effects can be obtained. In the server 3, with the probe data, a combination of the signal and the stop line is identified as a pairing candidate using a method of identifying a plurality of pairing candidates from among a plurality of signals in the intersection and a plurality of stop lines in the intersection. Then, the signal information and the stop line information are paired based on an identified result of the combination. According to the present embodiment, unlike a conventional technique in which the signal information and the stop line information are paired using partial optimization for one signal and one stop line, since the signal information and the stop line information are paired using overall optimization for a plurality of signals and a plurality of stop lines, pairing between the signal information and the stop line information can readily be completed for all of the signals in the intersection as the pairing objects.

Further, the server 3 is configured to pair the signal information and the stop line information for each lane. For example, in the nighttime or bad weather conditions and the like, it is impossible to identify whether the signal data in the camera image is image data corresponding to a signal in the travelling lane or is image data corresponding to an adjacent lane adjacent to the travelling lane or a road crossing the travelling lane. In this case, the signal information and the stop line information may be erroneously paired. However, according to the present embodiment, the vehicle identifies a lane on which the vehicle is travelling and the signal information and the stop line information are paired for each lane, thereby reducing a possibility of causing an erroneous pairing of the signal information and the stop line information. Further, the lane center line is identified, thereby associating the lane center line with the stop line. As a result, the lane center line can be associated with the signal.

Further, in the case where the server 3 performs the provisional pairing process with a provisional pairing, the stop line of the pairing candidate is identified based on the vehicle location when the signal of the pairing candidate is identified, and the signal information related to the signal of the pairing candidate and the stop line information related to the stop line identified as the pairing candidate are paired. In the case where the vehicle location at which the signal is identified as a pairing candidate corresponds to a location after entering the intersection area, a past vehicle trajectory is identified and the pairing candidate is identified to be a stop line at which the vehicle passes across when entering the intersection, whereby the signal information and the stop line information can be appropriately paired. As long as the vehicle location when identifying the pairing candidate is a location before entering the intersection, the vehicle trajectory is identified by prediction, and the pairing candidate is identified to be the stop line at which the vehicle passes across when entering the intersection, whereby the signal information and the stop line information can be appropriately paired.

Further, in the server 3, when a provisional pairing process is executed without a provisional pairing, a stop line as a pairing candidate is identified based on the position of the stop line with respect to the signal as the pairing candidate, and the signal information related to the signal as the pairing candidate and the stop line information related to the identified stop line as the pairing candidate are paired. The stop line existing in a normal vector direction of the signal or a direction opposite to the normal vector direction of the signal is identified, whereby the signal information and the stop line information can be appropriately paired. Even in the case where the stop line does not exist in both the normal vector direction of the signal and the direction opposite to the normal vector direction of the signal, identifying a stop line existing in the traveling direction of the vehicle on a road which is present in the normal vector direction of the signal as the pairing candidate, the signal information and the stop line information can be appropriately paired. In this case, when identifying the stop line as a pairing candidate existing at a position away from the signal by less than a predetermined distance, a stop line positioned significantly away from the signal can be suppressed from being erroneously identified as the pairing candidate.

Further, in the server 3, a provisional pairing process with a provisional pairing is executed. Hence, with the provisional pairing process where the signal information and the stop line information are provisionally paired before executing the integration process, dynamic information such as information of the lamp color of the signal, information of the vehicle speed, information of the trajectory of the vehicle and the like can be collected when executing the provisional pairing, and such the dynamic information can be utilized.

Further, in the server 3, a provisional pairing process without a provisional pairing is executed. Hence, with the pairing process where the signal information and the stop line information are paired after executing the integration process, the pairing between the signal information and the stop line information can be completed in one step.

In the on-vehicle equipment 2, the pairing information where the signal information of the signal in the intersection and the stop line information of the stop line are paired is acquired from the server 3, it is determined whether the acquired paired information is correct or incorrect and the determination thereof is transmitted to the server. Accordingly, the pairing information can be verified based on the correctness determination result of the pairing information transmitted from the on-vehicle equipment 2. As a result, accuracy of the pairing information is enhanced and also travelling control of the vehicle is enhanced, thereby constituting a safety system.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

According to the present disclosure, a configuration is exemplified in which the signal information and the stop line information for a vehicle are paired. However, in the case where a signal for a pedestrian or a bicycle is also provided in addition to the one for the vehicle, a pairing may be performed such that signal information for the pedestrian or the bicycle is added to the signal information and the stop line information for the vehicle.

This is not limited to a pairing for the signal information of a signal and the stop line information of the stop line based on the probe data transmitted from the same vehicle, but may pair the signal information of a signal and the stop line information of the stop line based on the probe data transmitted from different vehicles. For example, signal information X for a signal based on the probe data transmitted from a vehicle A and stop line information Y of a stop line based on the probe data transmitted from a vehicle B may be paired. A pairing for the signal information and the stop line information may not be necessarily completed based on the probe data transmitted from the same vehicle, but a pairing for the signal information and the stop line information may be completed based on the probe data transmitted from different vehicles.

As a method for identifying a plurality of pairing candidates, both the first method and the second method may be utilized. For a signal corresponding to the same pairing candidate, a program corresponding to the first method may be executed to identify the stop line of the pairing candidate and a program corresponding to the second method may be executed to identify the stop line of the pairing candidate.

For the signal corresponding to the same pairing candidate, when the stop line as the pairing candidate cannot be identified even when the program corresponding to the first method is executed, a program corresponding to the second method may be executed to identify the stop line. However, in the case where a stop line of the pairing candidate cannot be identified even when the program corresponding to the second method is executed, a program corresponding to the first method may be executed to identify the stop line of the pairing candidate. If there is another method different from the first and second methods, in the case where a stop line of the pairing candidate cannot be identified even when the program corresponding to the second method is executed, a program corresponding to another method may be executed to identify the stop line of the pairing candidate.

The signals of the pairing candidates may be divided, based on the positional information of respective signals, into signals to which the first method is applied and signals to which the second method is applied. Then, a program corresponding to the first method may be executed for the signals to which the first method is applied, thereby identifying the stop line of the pairing candidates, and a program corresponding to the second method may be executed for the signals to which the second method is applied, thereby identifying the stop line of the pairing candidates. Further, if there is another method other than the first and second methods, a program corresponding to another method may be executed for a signal to which another method is applied, thereby identifying the stop line of the pairing candidate.

The on-vehicle camera is not limited to a front camera that captures a front area of the vehicle, but may also be provided with a rear camera that captures a rear area of the vehicle in addition to the front camera. A signal of an intersection to which the vehicle firstly enters without turning a turn signal ON may be a signal as a pairing candidate.

When the vehicle stops before the intersection, the signal of the intersection and a stop line at which the vehicle stops may be identified as a pairing candidate of the signal and the stop line, and the signal and the stop line of the pairing candidate may be identified for each lane as long as the lane on which the vehicle travels is identified.

The control unit and method thereof disclosed in the present disclosure may be accomplished by a dedicated computer constituted of a processor and a memory programmed to execute one or more functions embodied by computer programs. Alternatively, the control unit and method thereof disclosed in the present disclosure may be accomplished by a dedicated computer provided by a processor configured of one or more dedicated hardware logic circuits. Further, the control unit and method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer-readable non-transitory tangible recording media.

### Conclusion

The present disclosure provides an apparatus that readily completes a pairing between signal information and stop line information for all of the signals in the intersection as pairing objects.

According to one aspect of the present disclosure, a probe data acquiring unit acquires probe data from a plurality of vehicles. A signal information identifying unit identifies, for a plurality of signals in an intersection, signal information related to respective signals based on the probe data. A stop line information identifying unit identifies, for a plurality of stop lines in the intersection, stop line information related to respective stop lines based on the probe data. A pairing unit identifies, using a method for identifying a plurality of pairing candidates, a combination of the signal and the stop line as pairing candidates among a plurality of signals in the intersection and a plurality of stop lines in the intersection, and pairs the signal information and the stop line information based on an identification result of the combination.

For probe data acquired from a plurality of vehicles, a method is utilized for identifying a plurality of pairing candidates from among a plurality of signals at an intersection and a plurality of stop lines at the intersection, thereby identifying combinations of a signal and a stop line as a pairing candidate. Then, the signal information and the stop line are paired based on a result of identifying the combinations. The signal information and the stop line information are paired using overall optimization for a plurality of signals and a plurality of stop lines. Hence, pairing between the signal information and the stop line information can readily be completed for all of the signals at the intersection as the pairing objects.

What is claimed is:

1. A map generation apparatus comprising:
a probe data acquiring unit that acquires probe data from a plurality of vehicles;
a signal information identifying unit that identifies, for a plurality of signals at an intersection, signal information related to respective signals based on the probe data;
a stop line information identifying unit that identifies, for a plurality of stop lines at the intersection, stop line information related to respective stop lines based on the probe data; and
a pairing unit that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing unit executes a provisional pairing process that provisionally pairs the signal information and the stop line information, executes an integration process that integrates a plurality of probe data and thereafter applies a statistical process using a result of the integration process to provisional pairing information generated by the provisional pairing process, thereby performing a determined pairing process in which the signal information and the stop line information are paired as a determined pair.

2. The map generation apparatus according to claim 1, wherein
the pairing unit identifies, as a method for identifying the pairing candidate, a stop line of a pairing candidate based on a vehicle location when identifying the signal as the pairing candidate, and pairs signal information related to a signal as the pairing candidate and stop line information related to the stop line identified as the pairing candidate of the signal.

3. The map generation apparatus according to claim 2, wherein
the pairing unit, when the vehicle location at which the signal is identified as a pairing candidate is a location after entering an intersection area, identifies a past vehicle trajectory, and identifies a stop line which the vehicle crosses when entering the intersection to be the pairing candidate.

4. The map generation apparatus according to claim 2, wherein
the pairing unit, when the vehicle location at which the signal is identified as a pairing candidate is a location before entering an intersection area, identifies a vehicle trajectory using a prediction, and identifies a stop line which the vehicle will cross when entering the intersection to be the pairing candidate.

5. A map generation apparatus comprising:
a probe data acquiring unit that acquires probe data from a plurality of vehicles;
a signal information identifying unit that identifies, for a plurality of signals at an intersection, signal information related to respective signals based on the probe data;
a stop line information identifying unit that identifies, for a plurality of stop lines at the intersection, stop line information related to respective stop lines based on the probe data; and
a pairing unit that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing unit executes a pairing process after executing an integration process that integrates a plurality of probe data to pair the signal information and the stop line information using a result of the integration process;
the pairing unit identifies, as a method for identifying the pairing candidate, a stop line of a pairing candidate based on a position of the stop line with respect to the signal as the pairing candidate, and pairs signal information related to the signal as the pairing candidate and stop line information related to the stop line identified as the pairing candidate of the signal; and
the pairing unit identifies a stop line existing in a normal vector direction of the signal as the pairing candidate or existing in a direction opposite to the normal vector direction thereof, to be the pairing candidate.

6. The map generation apparatus according to claim 5, wherein
the pairing unit identifies a stop line to be the pairing candidate, when existing in a normal vector direction of the signal as the pairing candidate or existing in a direction opposite to the normal vector direction thereof and a distance between the signal as the pairing candidate and the stop line being less than a predetermined distance.

7. A map generation apparatus comprising:
a probe data acquiring unit that acquires probe data from a plurality of vehicles;
a signal information identifying unit that identifies, for a plurality of signals at an intersection, signal information related to respective signals based on the probe data;
a stop line information identifying unit that identifies, for a plurality of stop lines at the intersection, stop line information related to respective stop lines based on the probe data; and
a pairing unit that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing unit executes a pairing process after executing an integration process that integrates a plurality of probe data to pair the signal information and the stop line information using a result of the integration process;
the pairing unit identifies, as a method for identifying the pairing candidate, a stop line of a pairing candidate based on a position of the stop line with respect to the signal as the pairing candidate, and pairs signal information related to the signal as the pairing candidate and stop line information related to the stop line identified as the pairing candidate of the signal; and
the pairing unit identifies, when no stop line exists in a normal vector direction of the signal as the pairing candidate and no stop line exists in a direction opposite to the normal vector direction thereof, a stop line existing in a travelling direction of a vehicle on a road in the normal vector direction of the signal as the pairing candidate, to be the pairing candidate.

8. The map generation apparatus according to claim 7, wherein
when no stop line exists in a normal vector direction of the signal as the pairing candidate and in a direction opposite to the normal vector direction thereof, and a stop line exists in a travelling direction of a vehicle on a road in the normal vector direction of the signal as the pairing candidate and a distance between the signal as the pairing candidate and the stop line being less than a predetermined distance, the pairing unit identifies the stop line existing in the travelling direction to be the pairing candidate.

9. The map generation apparatus according to claim 1, wherein
the map generation apparatus is provided with a lane identifying unit that identifies a lane based on the probe data; and
the pairing unit pairs the signal information and the stop line information for each lane which is identified by the lane identifying unit.

10. The map generation apparatus according to claim 1, wherein
the pairing unit identifies a stop line information identified based on probe data when a travelling speed is greater than or equal to a predetermined speed, to be a pairing candidate.

11. A map generation program causing a control unit of a map generation apparatus to execute processes comprising:
a probe data acquiring process that acquires probe data from a plurality of vehicles;
a signal information identifying process that identifies, for a plurality of signals in an intersection, signal information related to respective signals based on the probe data;
a stop line information identifying process that identifies, for a plurality of stop lines in the intersection, stop line information related to respective stop lines based on the probe data; and
a pairing process that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing process executes a provisional pairing process that provisionally pairs the signal information and the stop line information, executes an integration process that integrates a plurality of probe data and thereafter applies a statistical process using a result of the integration process to provisional pairing information generated by the provisional pairing process, thereby performing a determined pairing process in which the signal information and the stop line information are paired as a determined pair.

12. A map generation program causing a control unit of a map generation apparatus to execute processes comprising:
a probe data acquiring process that acquires probe data from a plurality of vehicles;
a signal information identifying process that identifies, for a plurality of signals at an intersection, signal information related to respective signals based on the probe data;
a stop line information identifying process that identifies, for a plurality of stop lines at the intersection, stop line information related to respective stop lines based on the probe data; and
a pairing process that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing process executes a pairing process after executing an integration process that integrates a plurality of probe data to pair the signal information and the stop line information using a result of the integration process;
the pairing process identifies, as a method for identifying the pairing candidate, a stop line of a pairing candidate based on a position of the stop line with respect to the signal as the pairing candidate, and pairs signal information related to the signal as the pairing candidate and stop line information related to the stop line identified as the pairing candidate of the signal; and
the pairing unit identifies a stop line existing in a normal vector direction of the signal as the pairing candidate or existing in a direction opposite to the normal vector direction thereof, to be the pairing candidate.

13. A map generation program causing a control unit of a map generation apparatus to execute processes comprising:
a probe data acquiring process that acquires probe data from a plurality of vehicles;
a signal information identifying process that identifies, for a plurality of signals at an intersection, signal information related to respective signals based on the probe data;
a stop line information identifying process that identifies, for a plurality of stop lines at the intersection, stop line information related to respective stop lines based on the probe data; and
a pairing process that identifies, using a method for identifying a plurality of pairing candidates, a combination of the signal and the stop line as a pairing candidate among a plurality of signals in the intersection and a plurality of stop lines in the intersection, and pairs the signal information and the stop line information based on an identification result of the combination, wherein
the pairing process executes a pairing process after executing an integration process that integrates a plurality of probe data to pair the signal information and the stop line information using a result of the integration process;
the pairing process identifies, as a method for identifying the pairing candidate, a stop line of a pairing candidate based on a position of the stop line with respect to the signal as the pairing candidate, and pairs signal information related to the signal as the pairing candidate and stop line information related to the stop line identified as the pairing candidate of the signal; and
the pairing process identifies, when no stop line exists in a normal vector direction of the signal as the pairing candidate and no stop line exists in a direction opposite to the normal vector direction thereof, a stop line existing in a travelling direction of a vehicle on a road in the normal vector direction of the signal as the pairing candidate, to be the pairing candidate.
